(19) United States
(12) Patent Application Publication
(10) Pub. No.: US 2026/0050124 A1
(43) Pub. Date: Feb. 19, 2026

(54) FOLDING OPTICAL SYSTEM, OPTICAL REPEATER, AND OPTICAL TRANSMISSION SYSTEM

(71) Applicant: NEC Corporation, Tokyo (JP)

(72) Inventor: Yusuke SHIMOMURA, Tokyo (JP)

(73) Assignee: NEC Corporation, Tokyo (JP)

(21) Appl. No.: 19/289,148

(22) Filed: Aug. 4, 2025

(30) Foreign Application Priority Data
Aug. 15, 2024 (JP) 2024-136827

(51) Int. Cl. G02B 6/293; H04B 10/29

(52) U.S. Cl. CPC G02B 6/29361; H04B 10/29

(57) ABSTRACT

Provided are a folding optical system, an optical repeater, an optical transmission system, and an optical folding method capable of suppressing deterioration of transmission quality. A folding optical system includes a wavelength selection mirror that allows first light having a first wavelength to pass through and reflects second light having a second wavelength, the first light and the second light having propagated through a first core among the first core and a second core included in a multi-core fiber, and a reflector that folds back the second light reflected by the wavelength selection mirror toward the wavelength selection mirror for coupling into the second core.

### INCORPORATION BY REFERENCE

This application is based upon and claims the benefit of priority from Japanese patent application No. 2024-135627, filed on Aug. 15, 2024, the disclosure of which is incorporated herein in its entirety by reference.

### TECHNICAL FIELD

The present disclosure relates to a folding optical system, an optical repeater, an optical transmission system, and an optical folding method.

### BACKGROUND ART

In recent years, to expand transmission capacity in optical communications, a multi-core fiber in which a plurality of cores are formed in one optical fiber has been utilized. For example, Patent Literature 1 describes that a bidirectional optical amplifying device for a multi-core fiber includes an FI/FO (Fan-in/Fan-out) and a bidirectional optical amplifier for a single-core fiber.

### CITATION LIST

### Patent Literature

[Patent Literature 1] International Patent Publication No. WO2023/105658

### SUMMARY

By disposing such optical amplifiers as described in Patent Literature 1 at predetermined intervals and relaying light, it is possible to suppress deterioration of the light during transmission through a multi-core fiber, making it possible to perform long-distance transmission.

On the other hand, to monitor a state of an optical amplifier and an optical fiber, for example, in an optical transmission system, light that is transmitted is folded back toward the transmission side, and the folded light is measured. However, in related techniques such as Patent Literature 1, since a configuration for performing monitoring in an optical transmission system for a multi-core fiber has not been taken into consideration, transmission quality may deteriorate depending on a configuration for folding back light.

In view of such an issue, an example object of the present disclosure is to provide a folding optical system, an optical repeater, an optical transmission system, and an optical folding method capable of suppressing deterioration of transmission quality.

A folding optical system according to an example aspect of the present disclosure includes a wavelength selection mirror that allows first light having a first wavelength to pass through and reflects second light having a second wavelength, the first light and the second light having propagated through a first core among the first core and a second core included in a multi-core fiber, and a reflector that folds back the second light reflected by the wavelength selection mirror toward the wavelength selection mirror for coupling into the second core.

An optical repeater according to an example aspect of the present disclosure includes a multi-core optical amplification fiber including a first core and a second core, and a folding optical system, in which the folding optical system includes a wavelength selection mirror that allows first light having a first wavelength to pass through and reflects second light having a second wavelength, the first light and the second light having propagated through the first core, and a reflector that folds back the second light reflected by the wavelength selection mirror toward the wavelength selection mirror for coupling into the second core.

An optical transmission system according to an example aspect of the present disclosure includes an optical repeater coupled between multi-core fibers, in which the optical repeater includes a multi-core optical amplification fiber including a first core and a second core, and a folding optical system, and the folding optical system includes a wavelength selection mirror that allows first light having a first wavelength to pass through and reflects second light having a second wavelength, the first light and the second light having propagated through the first core, and a reflector that folds back the second light reflected by the wavelength selection mirror toward the wavelength selection mirror for coupling into the second core.

An optical folding method according to an example aspect of the present disclosure includes, with a wavelength selection mirror, allowing first light having a first wavelength to pass through and reflecting second light having a second wavelength, the first light and the second light having propagated through a first core among the first core and a second core included in a multi-core fiber, and folding back the second light reflected by the wavelength selection mirror toward the wavelength selection mirror for coupling into the second core.

According to the present disclosure, it is possible to suppress deterioration of transmission quality.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a configuration diagram illustrating a configuration example of a related optical transmission system;

FIG. 2 is a configuration diagram illustrating a configuration example of a related optical repeater;

FIG. 3 is a configuration diagram illustrating a configuration example of a folding optical system according to some example embodiments;

FIG. 4 is a configuration diagram illustrating a configuration example of a folding optical system according to some example embodiments;

FIG. 5 is a diagram illustrating a configuration example of an optical transmission system according to some example embodiments;

FIG. 6 is a diagram illustrating wavelength bands for light transmitted in an optical transmission system according to some example embodiments;

FIG. 7 is a diagram illustrating a configuration example of an optical repeater according to some example embodiments;

FIG. 8 is a diagram for explaining an operation example of an optical repeater according to some example embodiments;

FIG. 9 is a diagram for explaining an operation example of an optical repeater according to some example embodiments;

FIG. 10 is a configuration diagram illustrating another configuration of a folding optical system according to some example embodiments;

FIG. 11 is a configuration diagram illustrating still another configuration of a folding optical system according to some example embodiments;

FIG. 12 is a configuration diagram illustrating still another configuration of a folding optical system according to some example embodiments;

FIG. 13 is a diagram illustrating a combination example of pairs of cores in a multi-core fiber according to some example embodiments;

FIG. 14 is a diagram illustrating a combination example of pairs of cores in a multi-core fiber according to some example embodiments;

FIG. 15 is a diagram illustrating a combination example of pairs of cores in a multi-core fiber according to some example embodiments;

FIG. 16 is a diagram illustrating a configuration example of an optical repeater according to some example embodiments;

FIG. 17 is a diagram for explaining an operation example of an optical repeater according to some example embodiments;

FIG. 18 is a diagram for explaining an operation example of an optical repeater according to some example embodiments;

FIG. 19 is a diagram illustrating a configuration example of an optical repeater according to some example embodiments;

FIG. 20 is a diagram for explaining an operation example of an optical repeater according to some example embodiments;

FIG. 21 is a diagram for explaining an operation example of an optical repeater according to some example embodiments; and

FIG. 22 is a diagram illustrating wavelength bands for light transmitted in an optical transmission system according to some example embodiments.

### EXAMPLE EMBODIMENTS

Hereinafter, example embodiments will be described with reference to the drawings. In the drawings, the same elements are denoted by the same reference signs, and redundant description will be omitted as necessary.

### Review of Related Art

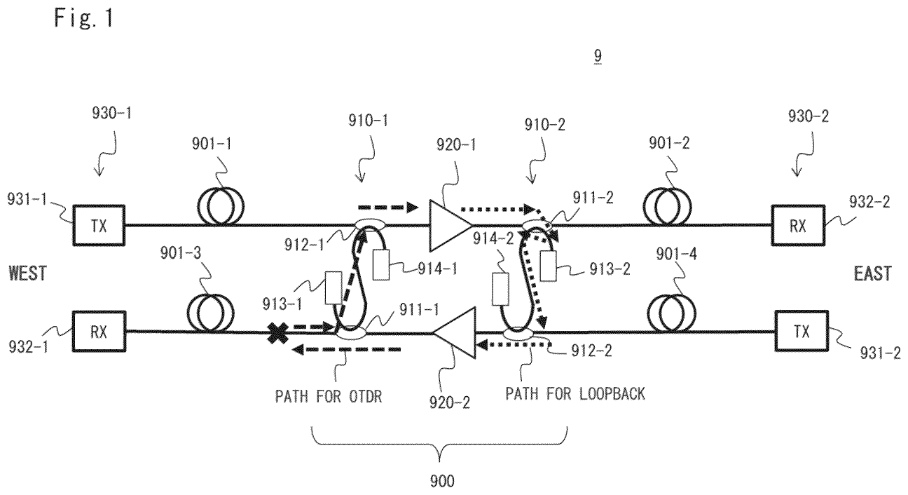

FIG. 1 illustrates a configuration example of a related optical transmission system 9. For example, the optical transmission system 9 is an optical submarine transmission system, and performs bidirectional transmission between an end station 930-1 on a WEST side and an end station 930-2 on an EAST side via a single-core fiber 901 (901 to 1 to 901-4).

The optical transmission system 9 includes an optical repeater 900 that relays signal light of the single-core fiber 901. For example, in the optical transmission system 9, a plurality of the optical repeaters 900 are disposed at predetermined intervals. In the example illustrated in FIG. 1, the optical repeater 900 is disposed between the single-core fibers 901-1 and 901-3 and the single-core fibers 901-2 and 901-4.

The optical repeater 900 includes a single-core erbium-doped fiber amplifier (SC-EDFA) 920 that is an optical amplifier that amplifies signal light of the single-core fiber 901. The SC-EDFA 920 amplifies light with a single-core EDF. In the example illustrated in FIG. 1, signal light transmitted from the WEST side via the single-core fiber 901-1 is amplified by an SC-EDFA 920-1, and the amplified signal light is transmitted toward the EAST side via the single-core fiber 901-2. Signal light transmitted from the EAST side via the single-core fiber 901-4 is amplified by an SC-EDFA 920-2, and the amplified signal light is transmitted toward the WEST side via the single-core fiber 901-3.

An optical submarine transmission system such as the optical transmission system 9 has a configuration in which light is folded back into an optical repeater for monitoring the system and estimating a loss location. By folding back the light, loopback measurements and optical time domain reflectometer (OTDR) measurements are performed. For example, light (monitoring light) having a wavelength different from that of signal light is folded back. In loopback measurements, an operational state of the optical amplifier is monitored by measuring output light of the optical amplifier, which has been folded back. In OTDR measurements, the optical fiber is monitored for an abnormality by measuring scattered light in the optical fiber.

As illustrated in FIG. 1, the optical repeater 900 of the optical transmission system 9 includes a folding portion 910 for loopback measurements and OTDR measurements. Since the SC-EDFA 920-1 and the SC-EDFA 920-2 of the optical repeater 900 include isolators that allow only light in one direction to pass through, folding portions 910-1 and 910-2 are disposed in front of and behind the SC-EDFA 920-1 and the SC-EDFA 920-2, for folding back light via the optical fibers in directions of the folding back.

The folding portion 910 includes couplers 911 and 912 and wavelength selection reflectors 913 and 914. The couplers 911 and 912 branch light of the single-core fiber 901. The wavelength selection reflectors 913 and 914 each reflect light having a selected wavelength (light to be folded) among beams of light branched from the couplers 911 and 912.

For example, in a case where loopback measurements are to be performed by folding back light transmitted from the WEST side toward the EAST side, light is outputted from a transmitter (TX) 931-1 on the WEST side to a receiver (RX) 932-2 on the EAST side, and part of the light outputted from the SC-EDFA 920-1 is folded back toward a receiver 932-1 on the WEST side in the folding portion 910-1. Specifically, part of the light outputted from the SC-EDFA 920-1 is branched by a coupler 911-2, a wavelength for loopback measurements is selected from the branched light by a wavelength selection reflector 913-2, and light having the selected wavelength is reflected. The reflected light is outputted from the coupler 911-2 to a coupler 912-2 on a single-core fiber side for performing transmission in a reverse direction, and is transmitted from the coupler 912-2 to the receiver 932-1 via the SC-EDFA 920-2 and the single-core fiber 901-3. The receiver 932-1 measures power of the received light and monitors an output state of the SC-EDFA 920-1. In a bidirectional optical system in which a plurality of optical amplifiers are coupled, folding back (looping back) light at an output stage of each of the optical amplifiers and measuring the folded light make it possible to identify one of the optical amplifiers, which is in an abnormal state such as there is a lowered output.

For example, in a case where light outputted from the EAST side toward the WEST side is to be folded back to perform OTDR measurements, the light is outputted from a transmitter 931-2 on the EAST side toward the receiver 932-1 on the WEST side, and part of scattered light scattered toward a side opposite to the transmission direction in the single-core fiber 901-3 is folded back toward the receiver 932-2 on the EAST side with the folding portion 910-1. Specifically, part of the scattered light of the single-core fiber 901-3 is branched by a coupler 911-1, and the branched light is outputted to a coupler 912-1 on a single-core fiber side for performing transmission of the branched light in a reverse direction, and is transmitted from the coupler 912-1 toward the receiver 932-2 via the SC-EDFA 920-1 and the single-core fiber 901-2. The receiver 932-2 measures the power of the received light and monitors a transmission state of the single-core fiber 901-3. In a bidirectional optical system in which a plurality of optical amplifiers are coupled, folding back scattered light in each of fibers (returning the scattered light to the transmission side) and measuring the folded light make it possible to identify a location in the fiber, which is in an abnormal state such as disconnection in the fiber.

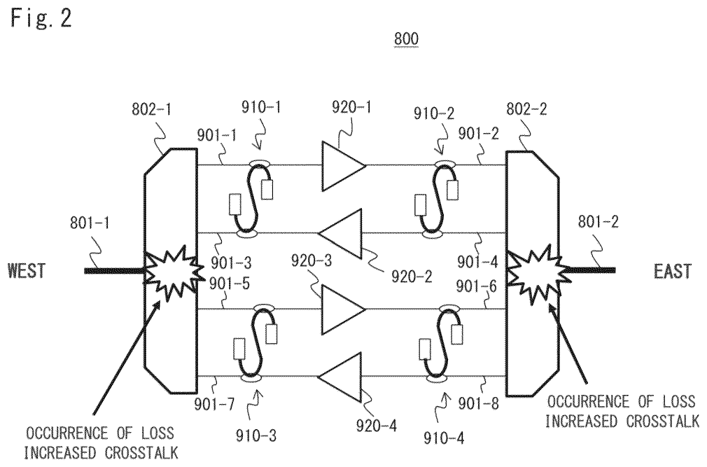

The inventors have considered to apply the configuration of the folding portions in the single-core fiber transmission system illustrated in FIG. 1 to a multi-core fiber transmission system. FIG. 2 illustrates a configuration example of a related optical repeater 800 that the inventors have considered.

In the example illustrated in FIG. 2, the optical repeater 800 is disposed between a multi-core fiber 801-1 and a multi-core fiber 801-2. For example, each of the multi-core fiber 801-1 and the multi-core fiber 801-2 is a multi-core fiber of four cores including a first core to a fourth core. Bidirectional transmission is performed with a pair of the first core and the second core, and bidirectional transmission is performed with a pair of the third core and the fourth core. The first core and the third core transmit signal light from the WEST side toward the EAST side, and the second core and the fourth core transmit signal light from the EAST side toward the WEST side.

The optical repeater 800 includes FI/FOs 802-1 and 802-2 for separating and coupling signal light in a multi-core fiber from and into signal light in a single-core fiber. In a case where bidirectional transmission is to be performed with pairs of cores, an SC-EDFA 920 is provided for each of the pairs of cores, similar to those illustrated in FIG. 1, and folding portions 910 are disposed in front of and behind the SC-EDFA 920.

For example, the FI/FO 802-1 converts signal light of the multi-core fiber 801-1 into signal light of the single-core fiber 901-1, the single-core fiber 901-3, a single-core fiber 901-5, and a single-core fiber 901-7. The FI/FO 802-2 converts signal light of the multi-core fiber 801-2 into signal light of the single-core fiber 901-2, the single-core fiber 901-4, a single-core fiber 901-6, and a single-core fiber 901-8. For signal light of the first core, the SC-EDFA 920-1 is disposed between the single-core fiber 901-1 and the single-core fiber 901-2, and, for signal light of the second core, the SC-EDFA 920-2 is disposed between the single-core fiber 901-3 and the single-core fiber 901-4. The folding portions 910-1 and 910-2 are disposed in front of and behind the SC-EDFA 920-1 and the SC-EDFA 920-2. For signal light of the third core, an SC-EDFA 920-3 is disposed between the single-core fiber 901-5 and the single-core fiber 901-6, and, for signal light of the fourth core, an SC-EDFA 920-4 is disposed between the single-core fiber 901-7 and the single-core fiber 901-8. Folding portions 910-3 and 910-4 are disposed in front of and behind the SC-EDFA 920-3 and the SC-EDFA 920-4.

With the configuration illustrated in FIG. 2, it is possible to perform, even in a multi-core fiber transmission system, similar to those illustrated in FIG. 1, loopback measurements and OTDR measurements for each of pairs of cores. However, in a case where the configuration of the single-core fiber transmission system illustrated in FIG. 1 is applied to a multi-core fiber transmission system, an FI/FO for branching signal light for each of cores is required as illustrated in FIG. 2. Therefore, components increase in number and a complicated configuration is required. In particular, if an FI/FO is used, there is such an issue that transmission quality of a signal is deteriorated due to loss of an optical signal and an increase in crosstalk noise between cores.

Therefore, the example embodiments aim to be able to suppress deterioration of transmission quality without using an FI/FO in a case of monitoring light is folded back in a multi-core fiber transmission system.

### First Example Embodiment

Next, a first example embodiment will be described. In the present example embodiment, outlines of some example embodiments will be described.

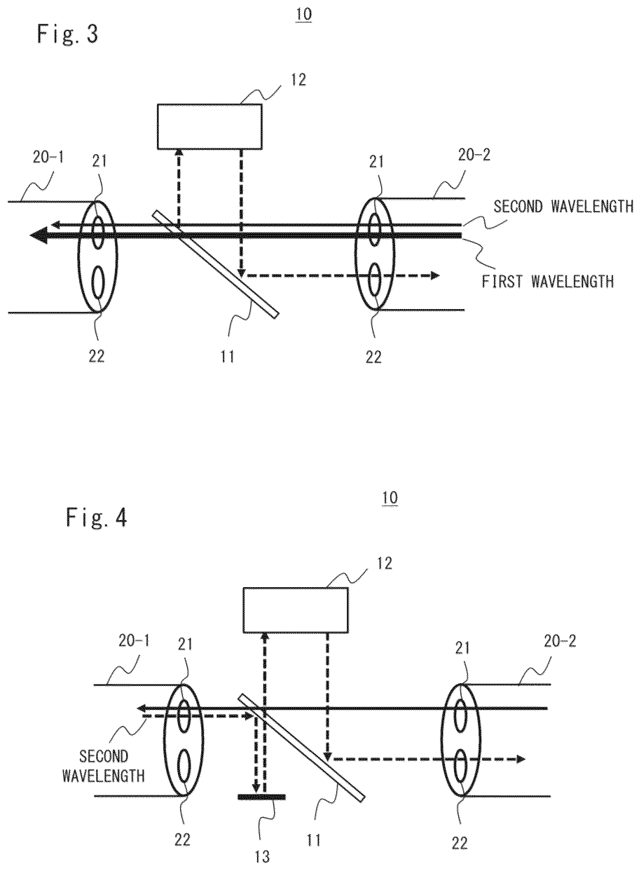

FIG. 3 illustrates a configuration example of a folding optical system 10 according to some example embodiments. For example, the folding optical system 10 folds back monitoring light in an optical transmission system that performs bidirectional transmission using a multi-core fiber. The folding optical system 10 may be disposed at a preceding stage or a subsequent stage of a multi-core fiber optical amplifier in an optical repeater in the optical transmission system.

In the example illustrated in FIG. 3, the folding optical system 10 folds back, between multi-core fibers 20 (20-1 and 20-2) each including a first core 21 and a second core 22, beams of light of the first core 21 or the second core 22. Between the first core 21 and the second core 22, transmission directions of signal light differ from each other, that is, the transmission directions are opposite to each other. Either the multi-core fiber 20-1 or the multi-core fiber 202 may be a multi-core fiber optical amplifier.

In the example illustrated in FIG. 3, the folding optical system 10 includes a wavelength selection mirror 11 and a reflector 12.

Among beams of light propagated through the first core 21, the wavelength selection mirror 11 allows first light having a first wavelength to pass through and reflects second light having a second wavelength. For example, the first light is signal light for performing communications in the optical transmission system. The second light is monitoring light for monitoring a state of the optical transmission system (the optical amplifier and the optical fibers, for example). The wavelength selection mirror 11 may reflect part of the second light having the second wavelength and allow the rest of the light to pass through. For example, the wavelength selection mirror 11 may be disposed to cross directions of optical axes of the first core 21 and the second core 22, and may reflect the second light in a direction orthogonal to the directions of the optical axes of the first core 21 and the second core 22. For example, the wavelength selection mirror 11 may be a dichroic mirror.

The reflector 12 folds back the second light reflected by the wavelength selection mirror 11 toward the wavelength selection mirror 11 for coupling into the second core 22. With this feature, it is possible to fold back the second light (monitoring light) via the second core 22 for loopback measurements. The reflector 12 moves in parallel an optical path of the second light reflected by the wavelength selection mirror 11, and folds back the second light toward a position on the wavelength selection mirror 11, the position crossing the direction of the optical axis of the second core 22. The reflector 12 may include a lens capable of allowing parallel light to condense and a reflection mirror capable of reflecting light from the lens at a light-condensing position of the lens. The reflector 12 may be a corner cube type reflector.

As illustrated in FIG. 4, the folding optical system 10 may further include a reflection mirror 13. The reflection mirror 13 is disposed on a side opposite to the reflector 12 with respect to the wavelength selection mirror 11. In this case, the wavelength selection mirror 11 reflects part of light having the second wavelength (scattered light), which is propagated in a direction opposite to the direction of the first light of the first core 21, toward the side opposite to the reflector 12. The reflection mirror 13 reflects the light reflected by the wavelength selection mirror 11 toward the side opposite to the reflector 12 again toward the wavelength selection mirror 11. The reflector 12 folds back the light that has passed through the wavelength selection mirror 11 toward the wavelength selection mirror 11 for coupling into the second core 22. With this feature, it is possible to fold back light (scattered light of monitoring light) via the second core 22 for OTDR measurements.

As described above, in the present example embodiment, two cores in which the transmission directions differ from each other in a single multi-core fiber are paired, and light having a predetermined wavelength (monitoring light) from a first core is folded back by using a spatial optical system for coupling into a second core. With this feature, to perform loopback measurements and OTDR measurements, it is possible to configure a folding portion with a simple configuration without using an FI/FO, making it possible to suppress deterioration of transmission quality.

### Second Example Embodiment

Next, a second example embodiment will be described. In the present example embodiment, a specific example of a folding optical system that folds back monitoring light for loopback measurements will be described.

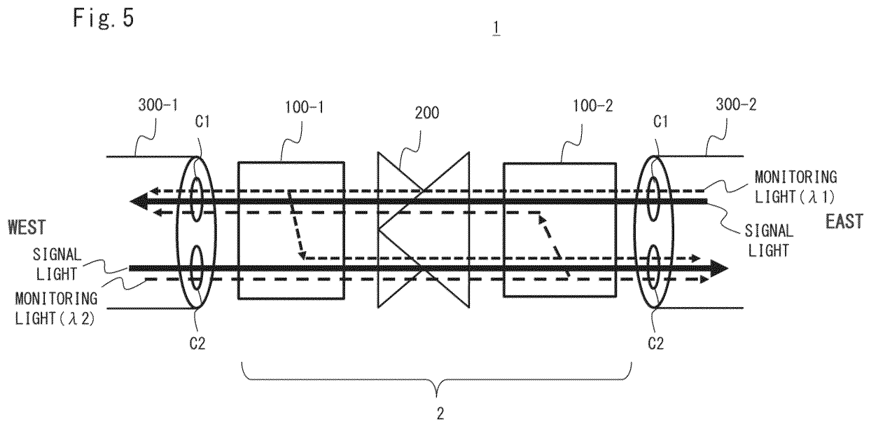

FIG. 5 illustrates a configuration example of an optical transmission system 1 according to some example embodiments. For example, the optical transmission system 1 is an optical submarine transmission system, and, similar to those illustrated in FIG. 1, performs bidirectional transmission between an end station on a WEST side and an end station on an EAST side via multi-core fibers 300 (300-1 to 300-2).

The optical transmission system 1 includes an optical repeater 2 that relays signal light of the multi-core fibers 300. For example, in the optical transmission system 1, a plurality of the optical repeaters 2 are disposed at predetermined intervals. In the example illustrated in FIG. 5, the optical repeater 2 is disposed between the multi-core fiber 300-1 and the multi-core fiber 300-2.

The optical repeater 2 includes an MC-EDFA 200 and folding optical systems 100 (100-1 and 100-2). The MC-EDFA 200 amplifies light with a multi-core EDF (MC-EDF). For example, the multi-core fibers 300-1 and 300-2 and the MC-EDF of the MC-EDFA 200 are multi-core fibers of two cores each including a core C1 and a core C2. With the core C1 and the core C2, in which the transmission directions differ from each other, bidirectional transmission is performed. The multi-core fibers 300-1 and 300-2 and the MC-EDF of the MC-EDFA 200 may include more cores than two cores, and may include a plurality of pairs of cores in which the transmission directions differ from each other.

The core C1 transmits signal light from the EAST side toward the WEST side, and the core C2 transmits signal light from the WEST side toward the EAST side. The signal light transmitted from the EAST side via the core C1 in the multi-core fiber 300-2 is amplified in the core C1 in the MC-EDFA 200, and the amplified signal light is transmitted toward the WEST side via the core C1 in the multi-core fiber 300-1. The signal light transmitted from the WEST side via the core C2 in the multi-core fiber 300-1 is amplified in the core C2 in the MC-EDFA 200, and the amplified signal light is transmitted toward the EAST side via the core C2 in the multi-core fiber 300-2.

The folding optical system 100-1 is disposed between the multi-core fiber 300-1 and the MC-EDFA 200 (on the WEST side with respect to the MC-EDFA 200). The folding optical system 100-1 allows the signal light transmitted from the EAST side via the core C1 in the multi-core fiber 300-2 and amplified in the core C1 in the MC-EDFA 200 to pass through toward the core C1 in the multi-core fiber 300-1. The folding optical system 100-1 folds back part of monitoring light (having a wavelength λ1) transmitted from the EAST side via the core C1 in the multi-core fiber 300-2 and amplified in the core C1 in the MC-EDFA 200, and allows the folded part to be transmitted toward the EAST side via the core C2 in the MC-EDFA 200 and the core C2 in the multi-core fiber 300-2. The folding optical system 100-1 allows the rest of the monitoring light, which is not folded back, to pass through toward the core C1 in the multi-core fiber 300-1. With this feature, it is possible to fold back the monitoring light with the optical repeater 2 at a next stage (on the WEST side).

The folding optical system 100-2 is disposed between the multi-core fiber 300-2 and the MC-EDFA 200 (on the EAST side with respect to the MC-EDFA 200). The folding optical system 100-2 allows the signal light transmitted from the WEST side via the core C2 in the multi-core fiber 300-1 and amplified in the core C2 in the MC-EDFA 200 to pass through toward the core C2 in the multi-core fiber 300-2. The folding optical system 100-2 folds back part of monitoring light (having a wavelength λ2) transmitted from the WEST side via the core C2 in the multi-core fiber 300-1 and amplified in the core C2 in the MC-EDFA 200, and allows the folded part to be transmitted toward the WEST side via the core C1 in the MC-EDFA 200 and the core C1 in the multi-core fiber 300-1. The folding optical system 100-2 allows the rest of the monitoring light, which is not folded back, to pass through toward the core C2 in the multi-core fiber 300-2. With this feature, it is possible to fold back the monitoring light with the optical repeater 2 at a next stage (on the EAST side).

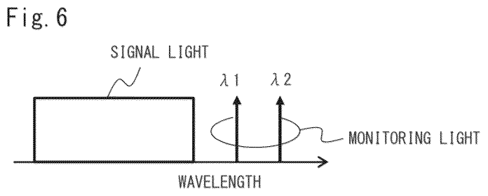

FIG. 6 illustrates wavelength bands for signal light and monitoring light transmitted in the optical transmission system 1 according to some example embodiments. The signal light is light for performing, in the optical transmission system 1, bidirectional communications between the WEST side and the EAST side (between the end stations). For example, a wavelength of the signal light may fall within a C-band or an L-band, or may be another wavelength. The wavelength of the signal light (the core C2) transmitted from the WEST side toward the EAST side and the wavelength of the signal light (the core C1) transmitted from the EAST side toward the WEST side may be identical to or may differ from each other.

The monitoring light is light used for monitoring the optical transmission system 1 (the optical amplifier and the optical fibers), and is, for example, light for loopback measurements.

In the example illustrated in FIG. 6, the wavelength of the signal light and the wavelength of the monitoring light differ from each other. For example, the wavelength of the monitoring light, which is longer than the wavelength of the signal light, may be shorter than the wavelength of the signal light. Since an operational state of the optical amplifier is monitored through loopback measurements, the wavelength of the monitoring light may be a wavelength falling within a wavelength band for the signal light or a wavelength falling within a wavelength band near the wavelength band for the signal light.

In the example illustrated in FIG. 6, the monitoring light includes light having the wavelength λ1 and light having the wavelength λ2. Between the monitoring light having the wavelength λ1 and the monitoring light having the wavelength λ2, the transmission directions differ from each other. For example, the monitoring light having the wavelength λ1 is transmitted from the EAST side toward the WEST side (the core C1), and part of the monitoring light having the wavelength λ1, which is amplified in the MC-EDFA 200, is folded back toward the EAST side (the core C2). The monitoring light having the wavelength λ2 is transmitted from the WEST side toward the EAST side (the core C2), and part of the monitoring light having the wavelength λ2, which is amplified in the MC-EDFA 200, is folded back toward the WEST side (the core C1).

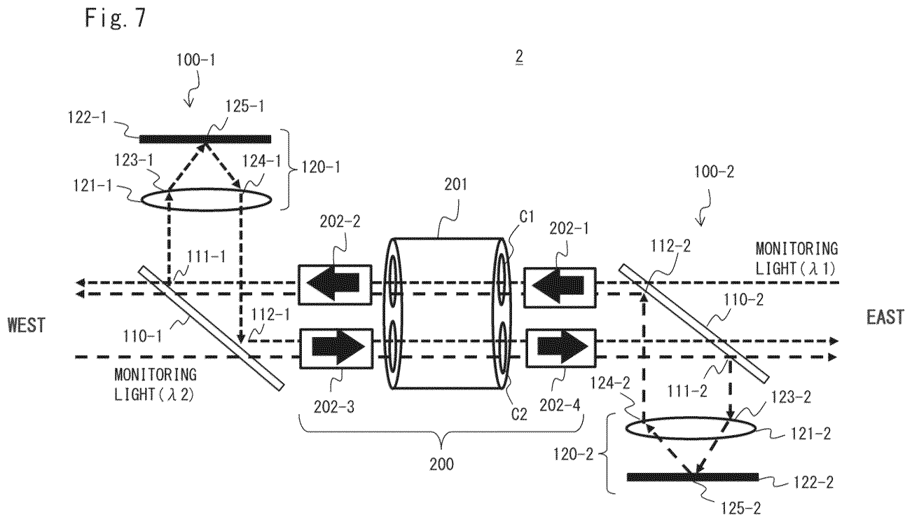

FIG. 7 illustrates a configuration example of the optical repeater 2 according to some example embodiments. In the example illustrated in FIG. 7, the MC-EDFA 200 includes an MC-EDF 201 and isolators 202 (202-1 to 202-4). The MC-EDF 201 is a multi-core EDF (multi-core optical amplification fiber). The MC-EDF 201 is an optical amplification unit that amplifies signal light to be inputted. By inputting excitation light together with signal light to the MC-EDF 201, the signal light is excited and amplified. As described above, for example, the MC-EDF 201 includes the two cores C1 and C2, amplifies signal light (monitoring light) inputted in a direction that differs for each of the cores, and outputs the amplified signal light (the amplified monitoring light).

The isolators 202-1 to 202-4 each allow only light in one direction to pass through. The isolators 202-1 to 202-4 are respectively disposed on an input side and an output side of each of the cores in the MC-EDF 201. The isolator 202-1 allows signal light (monitoring light) transmitted from the EAST side via the core C1 in the multi-core fiber 300-2 to pass through toward the WEST side, and to exit toward the core C1 in the MC-EDF 201. The isolator 202-2 allows the signal light (the monitoring light) amplified in and outputted from the core C1 in the MC-EDF 201 to pass through toward the WEST side, and to exit toward the core C1 in the multi-core fiber 300-1 on the WEST side. The isolator 202-3 allows signal light (monitoring light) transmitted from the WEST side via the core C2 in the multi-core fiber 300-1 to pass through toward the EAST side, and to exit toward the core C2 in the MC-EDF 201. The isolator 202-4 allows the signal light (the monitoring light) amplified in and outputted from the core C2 in the MC-EDF 201 to pass through toward the EAST side, and to exit toward the core C2 in the multi-core fiber 300-2 on the EAST side.

The folding optical system 100 (100-1 and 100-2) includes a dichroic mirror 110 (110-1 and 110-2) and a reflector 120 (120-1 and 120-2).

The dichroic mirror 110 allows signal light to pass through and reflects part of monitoring light. That is, the dichroic mirror 110 allows light having a wavelength of the signal light to pass through, reflects part of light having a wavelength of the monitoring light, and allows the rest of the light having the wavelength of the monitoring light to pass through. For example, the dichroic mirror 110-1 of the folding optical system 100-1 allows the signal light amplified in the core C1 in the MC-EDF 201 to pass through, reflects part of the monitoring light having the wavelength λ1, and allows the rest of the monitoring light having the wavelength λ1 to pass through. The dichroic mirror 110-2 of the folding optical system 100-2 allows the signal light amplified in the core C2 in the MC-EDF 201 to pass through, reflects part of the monitoring light having the wavelength λ2, and allows the rest of the monitoring light having the wavelength λ2 to pass through.

The dichroic mirror 110 is disposed to cross (at a position overlapping with) the directions of the optical axes of the core C1 and the core C2 in the MC-EDF 201. The dichroic mirror 110 is inclined at an angle of 45°with respect to the directions of the optical axes of the core C1 and the core C2, and reflects part of the monitoring light in a direction (toward the reflector) orthogonal to the directions of the optical axes of the core C1 and the core C2. A point at which the dichroic mirror 110 reflects (branches) the monitoring light from the core C1 or the core C2 in the MC-EDF 201 toward the reflector 120 is referred to as a branch point 111 (111-1 and 111-2). For example, the branch point 111-1 on the dichroic mirror 110-1 is a point at which the dichroic mirror 110-1 and the direction of the optical axis of the core C1 in the MC-EDF 201 cross each other. The branch point 111-2 on the dichroic mirror 110-2 is a point at which the dichroic mirror 110-2 and the direction of the optical axis of the core C2 in the MC-EDF 201 cross each other.

The dichroic mirror 110 reflects part of the monitoring light folded back from the reflector 120 in a direction orthogonal to the direction of the folding back (toward the core C1 or the core C2 in the MC-EDF 201). A point at which the monitoring light from the reflector 120 is reflected toward (coupled into) the core C1 or the core C2 in the MC-EDF 201 by the dichroic mirror 110 is referred to as a coupling point 112 (112-1 and 112-2). For example, the coupling point 112-1 on the dichroic mirror 110-1 is a point at which the dichroic mirror 110-1 and the direction of the optical axis of the core C2 in the MC-EDF 201 cross each other. The coupling point 112-2 on the dichroic mirror 110-2 is a point at which the dichroic mirror 110-2 and the direction of the optical axis of the core C1 in the MC-EDF 201 cross each other.

The reflector 120 moves (shifts) in parallel the optical path (the optical axis) of the monitoring light reflected from the dichroic mirror 110, and folds back the monitoring light toward the dichroic mirror 110 to achieve coupling of the monitoring light into another core. For example, the reflector 120-1 of the folding optical system 100-1 shifts and folds back the optical path of the monitoring light reflected by the dichroic mirror 110-1 from the core C1 in the MC-EDF 201 by the interval between the core C1 and the core C2 to achieve coupling of the monitoring light into the core C2 with the dichroic mirror 110-1. The reflector 120-2 of the folding optical system 100-2 shifts and folds back the optical path of the monitoring light reflected by the dichroic mirror 110-2 from the core C2 in the MC-EDF 201 by the interval between the core C1 and the core C2 to achieve coupling of the monitoring light into the core C1 with the dichroic mirror 110-2.

The reflector 120 includes a lens 121 and a mirror 122. For example, the lens 121 is a condenser lens such as a convex lens capable of allowing parallel light to condense. The lens 121 allows the optical path (the optical axis) of the monitoring light reflected at the branch point 111 on the dichroic mirror 110 to be inclined toward a center of the lens 121 (toward which the optical path is shifted). For example, the side toward which the optical path is shifted is a side approaching the MC-EDF 201. A point at which the lens 121 allows the monitoring light reflected from the dichroic mirror 110 to enter (to be inputted) is referred to as an input point 123. The input point 123 is on one end, which is nearer to an outer peripheral side than the center, on the lens 121, and is a point at a position facing the branch point 111 on the dichroic mirror 110. For example, an input point 123-1 on the reflector 120-1 is a point away in a direction orthogonal to the direction of the optical axis of the core C1 in the MC-EDF 201 from the branch point 111-1 on the dichroic mirror 110-1. An input point 123-2 on the reflector 120-2 is a point away in a direction orthogonal to the direction of the optical axis of the core C2 in the MC-EDF 201 from the branch point 111-2 on the dichroic mirror 110-2.

The lens 121 allows the optical path (the optical axis) of the monitoring light reflected by the mirror 122 to be inclined toward the coupling point 112 on the dichroic mirror 110. In other words, the lens 121 allows the monitoring light reflected by the mirror 122 to exit in a direction in parallel to the monitoring light reflected at the branch point 111 on the dichroic mirror 110. A point at which the lens 121 allows the monitoring light reflected from the mirror 122 to exit (to be outputted) is referred to as an output point 124. The output point 124 is on another one end, nearer to the outer peripheral side than the center, on the lens 121 (a side opposite to the input point 123), and is a point at a position facing the coupling point 112 on the dichroic mirror 110. An interval between the input point 123 and the output point 124 corresponds to the interval between the core C1 and the core C2 in the MC-EDF 201. For example, an output point 124-1 on the reflector 120-1 is a point away in a direction orthogonal to the direction of the optical axis of the core C2 in the MC-EDF 201 from the coupling point 112-1 on the dichroic mirror 110-1. An output point 124-2 on the reflector 120-2 is a point away in a direction orthogonal to the direction of the optical axis of the core C1 in the MC-EDF 201 from the coupling point 112-2 on the dichroic mirror 110-2.

The mirror 122 is a reflection mirror that reflects light from the lens 121. For example, the lens 121 is a condenser lens, and the mirror 122 reflects light from the lens 121 at a light-condensing position of the condenser lens. The mirror 122 reflects the monitoring light from the input point 123 on the lens 121 toward the output point 124 on the lens 121. A reflecting surface of the mirror 122 is perpendicular to the optical path of the monitoring light reflected from the dichroic mirror 110. A degree of an inclination of light entering the mirror 122 from the input point 123 on the lens 121 is equal to a degree of an inclination of light entering the output point 124 on the lens 121 from the mirror 122. A point at which the mirror 122 reflects (folds back) the monitoring light from the lens 121 is referred to as a folding point 125. For example, the folding point 125 is a position facing the center of the lens 121 (an intermediate point between the input point 123 and the output point 124). For example, a folding point 125-1 on the reflector 120-1 is an intermediate point between a direction orthogonal to the direction of the optical axis of the core C1 in the MC-EDF 201 from the branch point 111-1 on the dichroic mirror 110-1 and a direction orthogonal to the direction of the optical axis of the core C2 in the MC-EDF 201 from the coupling point 112-1 on the dichroic mirror 110-1. For example, a folding point 125-2 on the reflector 120-2 is an intermediate point between a direction orthogonal to the direction of the optical axis of the core C2 in the MC-EDF 201 from the branch point 111-2 on the dichroic mirror 110-2 and a direction orthogonal to the direction of the optical axis of the core C1 in the MC-EDF 201 from the coupling point 112-2 on the dichroic mirror 110-2.

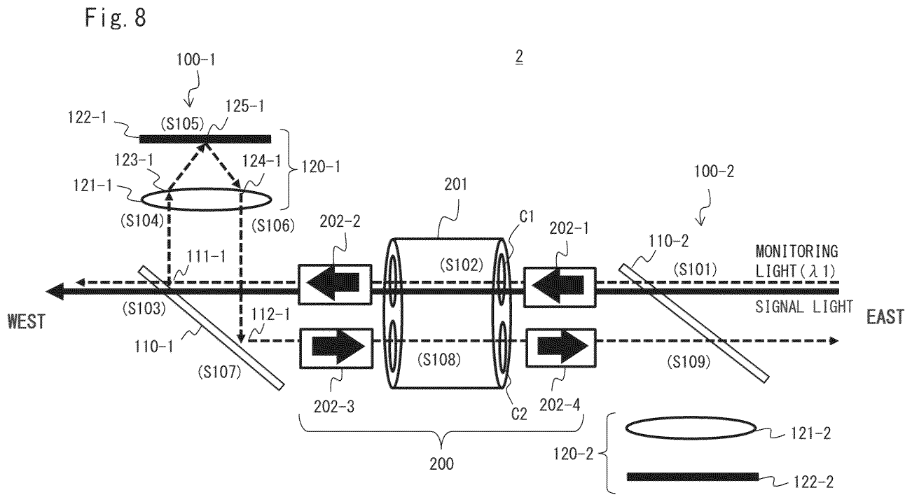

FIG. 8 illustrates an operation example of a case where the folding optical system 100-1 illustrated in FIG. 7 folds back monitoring light and loopback measurements are performed. In the example illustrated in FIG. 8, monitoring light having the wavelength λ1 from the EAST side is folded back toward the EAST side with the folding optical system 100-1. Signal light is constantly transmitted from the EAST side toward the WEST side via the optical repeater 2. Monitoring light having the wavelength λ1 may be constantly transmitted from the EAST side toward the WEST side for constantly performing loopback measurements. Monitoring light may be transmitted at a necessary cycle or timing to perform loopback measurements.

Monitoring light having the wavelength λ1 first propagates from the EAST side (the core C1 in the multi-core fiber 300-2), and enters the dichroic mirror 110-2 on the EAST side (S101). The dichroic mirror 110-2, which reflects part of light having the wavelength λ2 and allows the rest of the light having the wavelength λ2 and light having another wavelength to pass through, allows the entered monitoring light having the wavelength λ1 to pass through toward the core C1 in the MC-EDF 201.

Next, the monitoring light having the wavelength λ1, which has passed through the dichroic mirror 110-2, enters the core C1 (on the EAST side) in the MC-EDF 201 via the isolator 202-1 (S102). The MC-EDF 201 amplifies the entered monitoring light having the wavelength λ1 and allows the amplified monitoring light to exit the core C1 (on the WEST side).

Next, the monitoring light amplified in the core C1 in the MC-EDF 201 exits toward the branch point 111-1 on the dichroic mirror 110-1 via the isolator 202-2 (S103). The dichroic mirror 110-1, which reflects part of light having the wavelength λ1 and allows the rest of the light having the wavelength λ1 and light having another wavelength to pass through, after the monitoring light having the wavelength λ1 enters the branch point 111-1 from the isolator 202-2, reflects part of the monitoring light having the wavelength λ1 toward the input point 123-1 on the lens 121-1, and allows the rest of the monitoring light to pass through toward the WEST side (the core C1 in the multi-core fiber 300-1).

Next, after the monitoring light having the wavelength λ1 enters the input point 123-1 from the branch point 111-1 on the dichroic mirror 110-1, the lens 121-1 allows the monitoring light to exit toward the folding point 125-1 on the mirror 122-1 (S104). Next, after the monitoring light having the wavelength λ1 enters the folding point 125-1 from the lens 121-1, the mirror 122-1 reflects the monitoring light toward the output point 124-1 on the lens 121-1 (S105). Next, after the monitoring light having the wavelength λ1 enters the output point 124-1 from the mirror 122-1, the lens 121-1 allows the monitoring light to exit toward the coupling point 112-1 on the dichroic mirror 110-1 (S106).

Next, the dichroic mirror 110-1, which reflects part of light having the wavelength λ1 and allows the rest of the light having the wavelength λ1 and light having another wavelength to pass through, after the monitoring light having the wavelength λ1 enters the coupling point 112-1 from the output point 124-1 on the lens 121-1, reflects part of the monitoring light having the wavelength λ1 toward the core C2 in the MC-EDF 201 (S107).

Next, the monitoring light having the wavelength λ1, which has been reflected at the coupling point 112-1 on the dichroic mirror 110-1, enters the core C2 (on the WEST side) in the MC-EDF 201 via the isolator 202-3 (S108). The MC-EDF 201 amplifies the entered monitoring light having the wavelength λ1 and allows the amplified monitoring light to exit the core C2 (on the EAST side).

Next, the monitoring light amplified in the core C2 in the MC-EDF 201 exits toward the dichroic mirror 110-2 via the isolator 202-4 (S109). The dichroic mirror 110-2, which reflects part of light having the wavelength λ2 and allows the rest of the light having the wavelength λ2 and light having another wavelength to pass through, allows the monitoring light having the wavelength λ1 to pass through toward the EAST side (the core C2 in the multi-core fiber 300-2).

After that, the end station on the EAST side uses the monitoring light that has been folded back to perform loopback measurements. The end station on the EAST side measures the power of the received monitoring light and monitors the output state of the core C1 in the MC-EDF 201.

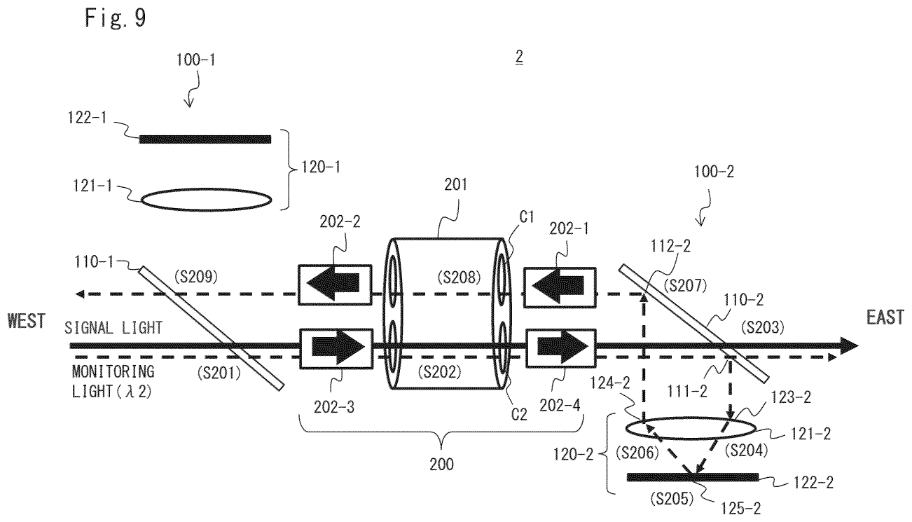

FIG. 9 illustrates an operation example of a case where the folding optical system 100-2 illustrated in FIG. 7 folds back monitoring light and loopback measurements are performed. In the example illustrated in FIG. 9, monitoring light having the wavelength λ2 from the WEST side is folded back in the folding optical system 100-2. Signal light is constantly transmitted from the WEST side toward the EAST side via the optical repeater 2, similar to those illustrated in FIG. 8. Monitoring light having the wavelength λ2 may be constantly transmitted from the WEST side toward the EAST side for constantly performing loopback measurements.

Monitoring light may be transmitted at a necessary cycle or timing to perform loopback measurements.

Monitoring light having the wavelength λ2, which is propagated from the WEST side (the core C2 in the multi-core fiber 300-1), first enters the dichroic mirror 110-1 on the WEST side (S201). The dichroic mirror 110-1, which reflects part of light having the wavelength λ1 and allows the rest of the light having the wavelength λ1 and light having another wavelength to pass through, allows the entered monitoring light having the wavelength λ2 to pass through toward the core C2 in the MC-EDF 201.

Next, the monitoring light having the wavelength λ2, which has passed through the dichroic mirror 110-1, enters the core C2 (on the WEST side) in the MC-EDF 201 via the isolator 202-3 (S202). The MC-EDF 201 amplifies the entered monitoring light having the wavelength λ2 and allows the amplified monitoring light to exit the core C2 (on the EAST side).

Next, the monitoring light amplified in the core C2 in the MC-EDF 201 exits toward the branch point 111-2 on the dichroic mirror 110-2 via the isolator 202-4 (S203). The dichroic mirror 110-2, which reflects part of light having the wavelength λ2 and allows the rest of the light having the wavelength λ2 and light having another wavelength to pass through, after the monitoring light having the wavelength λ2 enters the branch point 111-2 from the isolator 202-4, reflects part of the monitoring light having the wavelength λ2 toward the input point 123-2 on the lens 121-2, and allows the rest of the monitoring light to pass through toward the EAST side (the core C2 in the multi-core fiber 300-2).

Next, after the monitoring light having the wavelength λ2 enters the input point 123-2 from the branch point 111-2 on the dichroic mirror 110-2, the lens 121-2 allows the monitoring light to exit toward the folding point 125-2 on the mirror 122-2 (S204). Next, after the monitoring light having the wavelength λ2 enters the folding point 125-2 from the lens 121-2, the mirror 122-2 reflects the monitoring light toward the output point 124-2 on the lens 121-2 (S205). Next, after the monitoring light having the wavelength λ2 enters the output point 124-2 from the mirror 122-2, the lens 121-2 allows the monitoring light to exit toward the coupling point 112-2 on the dichroic mirror 110-2 (S206).

Next, the dichroic mirror 110-2, which reflects part of light having the wavelength λ2 and allows the rest of the light having the wavelength λ2 and light having another wavelength to pass through, after the monitoring light having the wavelength λ2 enters the coupling point 112-2 from the output point 124-2 on the lens 121-2, reflects part of the monitoring light having the wavelength λ2 toward the core C1 in the MC-EDF 201 (S207).

Next, the monitoring light having the wavelength λ2, which has been reflected at the coupling point 112-2 on the dichroic mirror 110-2, enters the core C1 (on the EAST side) in the MC-EDF 201 via the isolator 202-1 (S208). The MC-EDF 201 amplifies the entered monitoring light having the wavelength λ2 and allows the amplified monitoring light to exit the core C1 (on the WEST side).

Next, the monitoring light amplified in the core C1 in the MC-EDF 201 exits toward the dichroic mirror 110-1 via the isolator 202-2 (S209). The dichroic mirror 110-1, which reflects part of light having the wavelength λ1 and allows the rest of the light having the wavelength λ1 and light having another wavelength to pass through, allows the monitoring light having the wavelength λ2 to pass through toward the WEST side (the core C1 in the multi-core fiber 300-1).

After that, the end station on the WEST side uses the monitoring light that has been folded back to perform loopback measurements. The end station on the WEST side measures the power of the received monitoring light and monitors the output state of the core C2 in the MC-EDF 201.

The present example embodiment includes, as described above, a folding optical system in which, in multi-core fiber bidirectional transmission, each of the cores uses monitoring light having a wavelength different from a wavelength of signal light and the cores in which the transmission directions differ from each other are paired in a single multi-core fiber to achieve coupling of part of monitoring light propagating through a certain one of the cores into another one of the cores. For example, a folding optical system is configured to include a reflector using dichroic mirrors in which reflection wavelengths differ from each other and lenses. With this feature, it is possible to perform loopback measurements without performing branching for each core with an FI/FO, and thus no FI/FO is necessary, making it possible to suppress deterioration of transmission quality.

### <First Modified Example of Second Example Embodiment>

Although, in the example described above, the reflector 120 in the folding optical system 100 has been configured with the lens 121 and the mirror 122, the present disclosure is not limited to the example, and other configurations may be used.

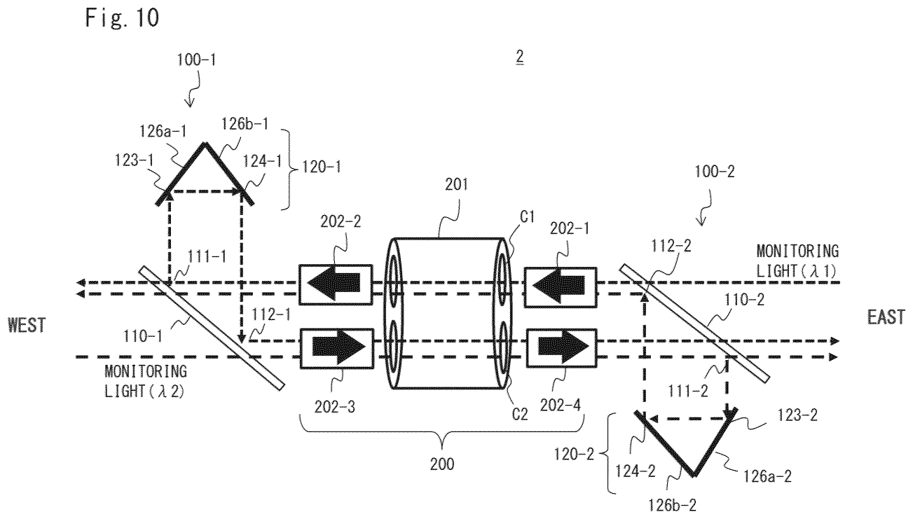

FIG. 10 illustrates another configuration example of the reflector 120 in the folding optical system 100. In the example illustrated in FIG. 10, the reflector 120 is a corner cube type reflector. Other configurations are similar to those illustrated in FIG. 7.

For example, the reflector 120 includes reflective plates 126a and 126b coupled to each other at a right angle. With the reflective plate 126a (at the input point 123), monitoring light from the branch point 111 on the dichroic mirror 110 is reflected toward the reflective plate 126b. With the reflective plate 126b (at the output point 124), the monitoring light from the reflective plate 126a is reflected and folded back toward the coupling point 112 on the dichroic mirror 110.

### <Second Modified Example of Second Example Embodiment>

For example, since the interval between the two cores in the multi-core fiber is several ten μm, it may be difficult to implement the folding optical system 100. Therefore, in a folding optical system, the interval between beams of light from the two cores (the interval between the optical axes) may be magnified. With this feature, it is possible to improve folding accuracy by the dichroic mirror 110 and the reflector 120.

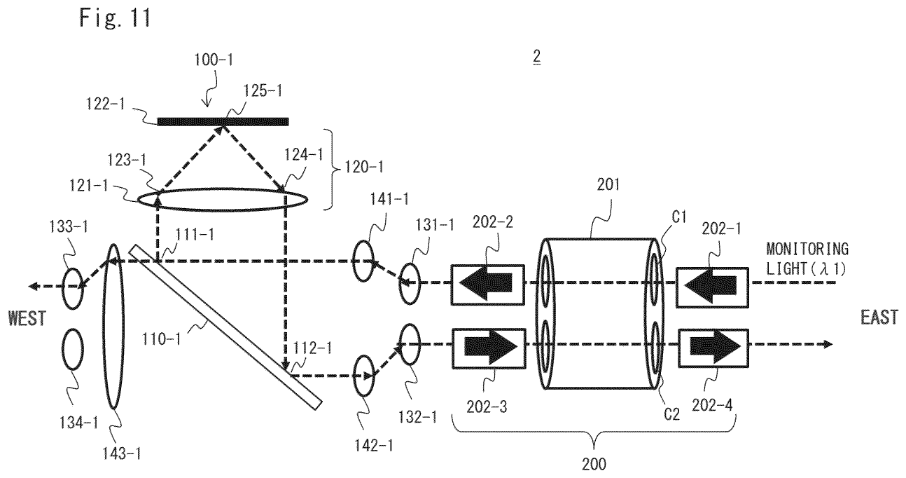

FIG. 11 illustrates another configuration example of the folding optical system 100. Although FIG. 11 illustrates only the configuration of the folding optical system 100-1, the folding optical system 100-2 has a similar or identical configuration.

In the example illustrated in FIG. 11, to magnify the interval between the core C1 and the core C2, the folding optical system 100-1 includes magnifying lenses 131-1 to 134-1 and parallel lenses 141-1 to 143-1. The magnifying lenses 131-1 to 134-1 allow the optical paths (the optical axes) of beams of monitoring light (signal light) to be inclined in directions of magnifying the interval of the beams of the monitoring light (the signal light) between the core C1 and the core C2. The parallel lenses 141-1 to 143-1 allow the optical paths of the beams of monitoring light (signal light), which have been inclined in the directions of magnifying the interval of the beams of monitoring light (signal light) between the core C1 and the core C2 to be returned to run in directions (parallel directions) identical to the directions of the optical axes of the cores.

The magnifying lenses 131-1 and 132-1 are disposed between the dichroic mirror 110-1 and the MC-EDF 201 (the isolators 202-2 and 202-3). The magnifying lenses 131-1 and 132-1 may be a single lens. The parallel lenses 141-1 and 142-1 are disposed between the dichroic mirror 110-1 and the magnifying lenses 131-1 and 132-1. The parallel lenses 141-1 and 142-1 may be a single lens. The magnifying lenses 133-1 and 134-1 are disposed between the dichroic mirror 110 and the WEST side (the multi-core fiber 300-1). The magnifying lenses 133-1 and 134-1 may be a single lens. The parallel lens 143-1 is disposed between the dichroic mirror 110-1 and the magnifying lenses 133-1 and 134-1. The parallel lens 143-1 may be two lenses.

For example, the magnifying lens 131-1 allows monitoring light (signal light) from the core C1 in the MC-EDF 201 to exit toward the parallel lens 141-1 in a direction of magnifying the interval between the optical axes of the core C1 and the core C2. The parallel lens 141-1 allows the monitoring light (the signal light) from the magnifying lens 131-1 to exit toward the branch point 111-1 on the dichroic mirror 110-1 in a direction in parallel to the optical axis of the core. The dichroic mirror 110-1 reflects part of the monitoring light, which has passed through the magnifying lens 131-1 and the parallel lens 141-1, and allows the monitoring light folded back from the reflector 120-1 to exit toward the parallel lens 142-1.

The parallel lens 142-1 allows the monitoring light (the signal light from the WEST side) from the coupling point 112-1 on the dichroic mirror 110-1 to exit toward the magnifying lens 132-1 in a direction of reducing the interval between the optical axes of the core C1 and the core C2. The magnifying lens 132-1 allows the monitoring light (the signal light) from the parallel lens 142-1 to exit toward the core C2 in the MC-EDF 201 in a direction identical to the direction of the optical axis of the core.

The parallel lens 143-1 allows the signal light (part of the monitoring light) passed through the branch point 111-1 on the dichroic mirror 110-1 to exit toward the magnifying lens 133-1 in a direction of reducing the interval between the optical axes of the core C1 and the core C2. The magnifying lens 133-1 allows the signal light (the part of the monitoring light) from the parallel lens 143-1 to exit toward the WEST side (the core C1 in the multi-core fiber 300-2) in the direction identical to the direction of the optical axis of the core.

The magnifying lens 134-1 allows signal light from the WEST side (the core C2 in the multi-core fiber 300-1) to exit toward the parallel lens 143-1 in a direction of magnifying the interval between the optical axes of the core C1 and the core C2. The parallel lens 143-1 allows the signal light from the magnifying lens 134-1 to exit toward the dichroic mirror 110-1 in the direction in parallel to the direction of the optical axis of the core.

### <Third Modified Example of Second Example Embodiment>

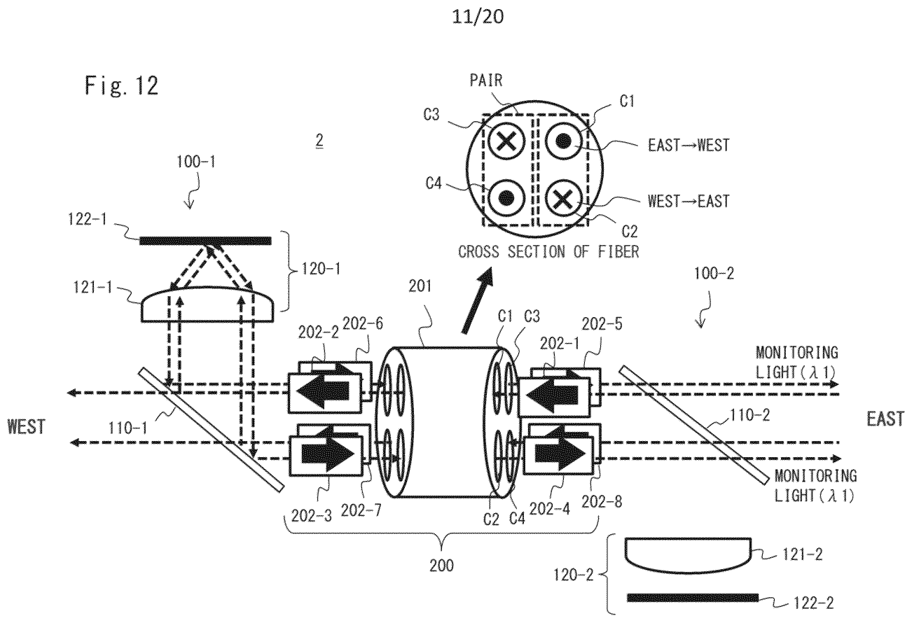

The multi-core fiber 300 and the MC-EDF 201 may each be a multi-core fiber of four cores. FIG. 12 illustrates another configuration example of the folding optical system 100, and illustrates a configuration example in a case of a multi-core fiber of four cores. In the example illustrated in FIG. 12, the multi-core fiber 300 and the MC-EDF 201 each include cores C1 to C4. The core C1 and the core C2 are adjacent to each other, and configure a pair of cores in which the transmission directions differ from each other, similar to the example described above. Similar to the core C1 and the core C2, the core C3 and the core C4 are adjacent to each other, and configure a pair of cores in which the transmission directions differ from each other.

The core C1 and the core C3 are also adjacent to each other, in which the transmission directions differ from each other. The core C2 and the core C4 are also adjacent to each other, in which the transmission directions differ from each other. Therefore, the core C1 and the core C3 may be a pair of the cores, and the core C2 and the core C4 may be a pair of the cores.

For example, a folding optical system 100 that is similar to that in the example described above may be disposed for each pair, that is, for the pair of the core C1 and the core C2 and for the pair of the core C3 and the core C4. That is, a folding optical system 100 (100-1 and 100-2) in which monitoring light is folded back between the core C1 and the core C2 and a folding optical system 100 (100-1 and 100-2) in which monitoring light is folded back between the core C3 and the core C4 may be provided.

As illustrated in FIG. 12, in the single folding optical system 100 (one for each of the WEST side and the EAST side), monitoring light may be folded back in the pair of the core C1 and the core C2 and monitoring light may be folded back in the pair of the core C3 and the core C4. That is, two pairs of beams of monitoring light may be folded back by the single dichroic mirror 110, the single lens 121, and the single mirror 122. The dichroic mirror 110 reflects monitoring light from one of the core C1 and the core C2 and monitoring light from one of the core C3 and the core C4, and the reflector 120 (the lens 121 and the mirror 122) folds back the beams of monitoring light for coupling into another one of the core C1 and the core C2 and another one of the core C3 and the core C4, respectively. A flow of light in the folding optical system 100-2, the illustration of which is omitted in FIG. 12, is similar or identical to that in the folding optical system 100-1.

In the example illustrated FIG. 12, the dichroic mirror 110-1 allows signal light to pass through and reflects part of monitoring light having the wavelength λ1, similar to those illustrated in FIG. 7. The dichroic mirror 110-1 reflects part of beams of monitoring light having the wavelength λ1 from the core C1 and the core C4 in the MC-EDF 201 toward the reflector 120-1. The dichroic mirror 110-1 reflects part of the beams of monitoring light having the wavelength λ1 (the monitoring light from the core C1 and the core C4), which have been folded back from the reflector 120-1, toward the cores C2 and C3 in the MC-EDF 201, respectively.

The dichroic mirror 110-2 allows signal light to pass through and reflects part of monitoring light having the wavelength λ2, similar to those illustrated in FIG. 7. The dichroic mirror 110-2 reflects part of beams of monitoring light having the wavelength λ2 from the core C2 and the core C3 in the MC-EDF 201 toward the reflector 120-2. The dichroic mirror 110-2 reflects part of the beams of monitoring light having the wavelength λ2 (the monitoring light from the core C2 and the core C3), which has been folded back from the reflector 120-2, toward the cores C1 and C4 in the MC-EDF 201, respectively.

The reflector 120 includes the lens 121 and the mirror 122, similar to those illustrated in FIG. 7. In this case, if the lens 121 is a cylindrical lens, it is possible to fold back beams of monitoring light from each of pairs with one lens. The reflector 120-1 folds back the beams of monitoring light having the wavelength λ1 from the core C1 and the core C4, which are reflected by the dichroic mirror 110-1, toward the dichroic mirror 110-1 with the lens 121-1 and the mirror 122-1 for coupling into the core C2 and the core C3, respectively. The reflector 120-2 folds back the beams of monitoring light having the wavelength λ2 from the core C2 and the core C3, which are reflected by the dichroic mirror 110-2, toward the dichroic mirror 110-2 with the lens 121-2 and the mirror 122-2 for coupling into the core C1 and the core C4, respectively.

### <Fourth Modified Example of Second Example Embodiment>

The multi-core fiber 300 and the MC-EDF 201 may each be a multi-core fiber of six or more cores. Even in a multi-core fiber of six or more cores (even-number cores), the cores in which the transmission directions differ from each other may be paired, the folding optical system 100 may be provided for each of the pairs of the cores, similar to those illustrated in FIG. 7, and beams of monitoring light may be folded back between the cores in each of the pairs.

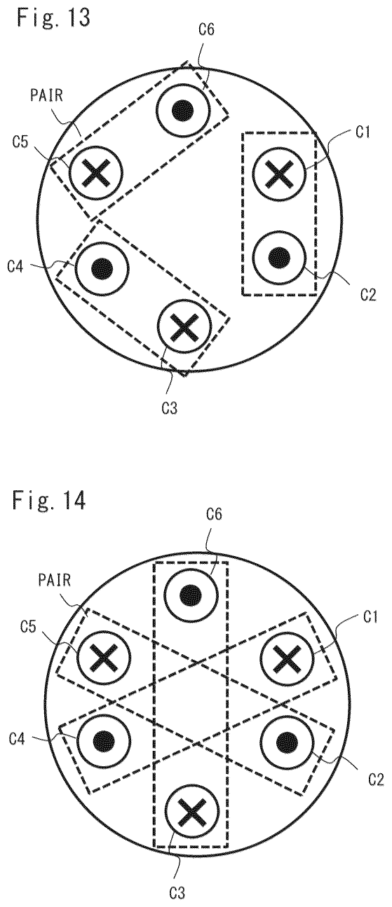

FIGS. 13 to 15 illustrate examples of combinations of pairs of cores each in a case of a multi-core fiber of six cores. In the examples illustrated in FIGS. 13 to 15, the multi-core fiber 300 and the MC-EDF 201 each include cores C1 to C6. The cores C1 to C6 are disposed side by side along an outer periphery of the fiber. In the cores adjacent to each other, among the cores C1 to C6, the transmission directions differ from each other.

In the example illustrated in FIG. 13, the cores adjacent to each other configure a pair of the cores in which the transmission directions differ from each other. The core C1 and the core C2 form a pair of the cores, the core C3 and the core C4 form a pair of the cores, and the core C5 and the core C6 form a pair of the cores. In this case, the folding optical system 100 in which monitoring light is folded back between the core C1 and the core C2, the folding optical system 100 in which monitoring light is folded back between the core C3 and the core C4, and the folding optical system 100 in which monitoring light is folded back between the core C5 and the core C6 may be provided.

In the example illustrated in FIG. 14, two of the cores, which face each other via the center of the fiber, form a pair of the cores in which the transmission directions differ from each other. The core C1 and the core C4 form a pair of the cores, the core C2 and the core C5 form a pair of the cores, and the core C3 and the core C6 form a pair of the cores. In this case, the folding optical system 100 in which monitoring light is folded back between the core C1 and the core C4, the folding optical system 100 in which monitoring light is folded back between the core C2 and the core C5, and the folding optical system 100 in which monitoring light is folded back between the core C3 and the core C6 may be provided.

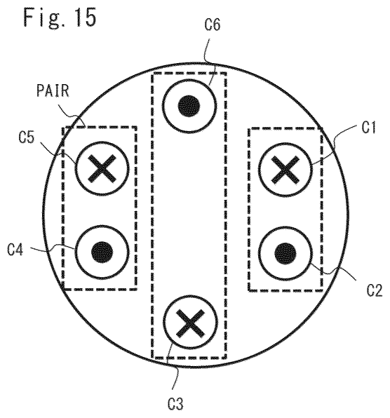

In the example illustrated in FIG. 15, two of the cores, which face each other in one direction (for example, a longitudinal direction of the drawing) in the fiber form a pair of the cores in which the transmission directions differ from each other. The core C1 and the core C2 form a pair of the cores, the core C3 and the core C6 form a pair of the cores, and the core C4 and the core C5 form a pair of the cores. In this case, the folding optical system 100 in which monitoring light is folded back between the core C1 and the core C2, the folding optical system 100 in which monitoring light is folded back between the core C3 and the core C6, and the folding optical system 100 in which monitoring light is folded back between the core C4 and the core C5 may be provided. Similar to those illustrated in FIG. 12, monitoring light may be folded back between the core C1 and the core C2, between the core C3 and the core C6, and between the core C4 and the core C5 in the single folding optical system 100 (with the dichroic mirror 110, the lens 121, and the mirror 122).

### Third Example Embodiment

Next, a third example embodiment will be described. In the present example embodiment, an example in which the dichroic mirror of the folding optical system illustrated in the second example embodiment reflects beams of monitoring light respectively having two types of wavelengths will be described.

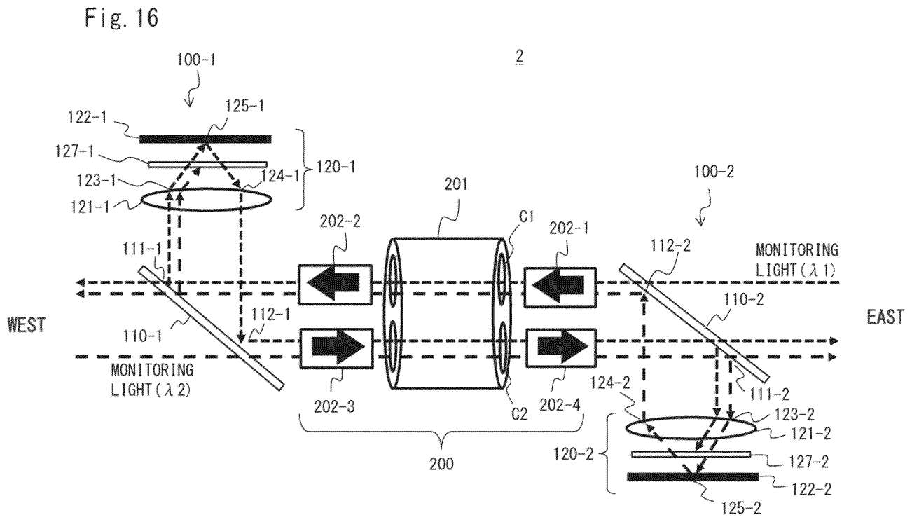

FIG. 16 illustrates a configuration example of the optical repeater 2 according to some example embodiments. In the example illustrated FIG. 16, the dichroic mirror 110-1 allows signal light to pass through and reflects part of monitoring light having the wavelength λ1 and part of monitoring light having the wavelength λ2. The dichroic mirror 110-2 also similarly allows signal light to pass through and reflects part of monitoring light having the wavelength λ1 and part of monitoring light having the wavelength λ2.

In addition to the configuration illustrated in FIG. 7, a filter 127 (127-1 and 127-2) that allows only light having a wavelength, which is folded back in the folding optical system 100, to pass through is provided. For example, the filter 127-1 allows only monitoring light having the wavelength λ1 to pass through. For example, the filter 127-2 allows only monitoring light having the wavelength λ2 to pass through. For example, the filter 127 is disposed between the lens 121 and the mirror 122. The filter 127 may be disposed between the lens 121 and the dichroic mirror 110. Others are similar to those illustrated in FIG. 7.

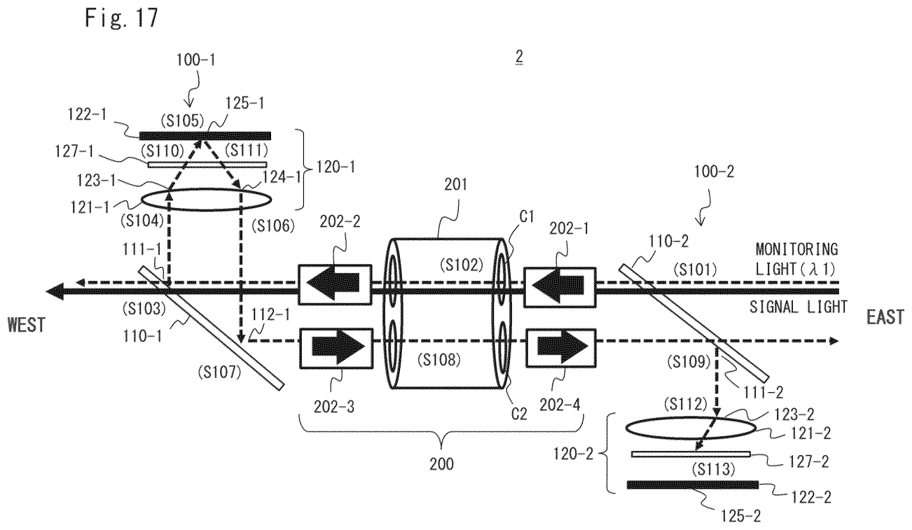

FIG. 17 illustrates an operation example of a case where the folding optical system 100-1 illustrated in FIG. 16 folds back monitoring light and loopback measurements are performed. In the example illustrated in FIG. 17, similar to those illustrated in FIG. 8, monitoring light having the wavelength λ1 from the EAST side is folded back toward the EAST side in the folding optical system 100-1.

Monitoring light having the wavelength λ1 first propagates from the EAST side (the core C1 in the multi-core fiber 300-2), and enters the dichroic mirror 110-2 on the EAST side (S101). The dichroic mirror 110-2, which reflects part of beams of light having the wavelengths λ1 and λ2 and allows the rest of the beams of light having the wavelengths λ1 and λ2 and light having another wavelength to pass through, allows part of the entered monitoring light having the wavelength λ1 to pass through toward the core C1 in the MC-EDF 201.

Next, similar to those illustrated in FIG. 8, the monitoring light having the wavelength λ1, which has passed through the dichroic mirror 110-2, enters, via the isolator 202-1, the core C1 in the MC-EDF 201 for amplification (S102). The amplified monitoring light exits toward the branch point 111-1 on the dichroic mirror 110-1 via the isolator 202-2 (S103). The dichroic mirror 110-1, which reflects part of the beams of light having the wavelengths λ1 and λ2 and allows the rest of the beams of light having the wavelengths λ1 and λ2 and light having another wavelength to pass through, after the monitoring light having the wavelength λ1 enters the branch point 111-1 from the isolator 202-2, reflects part of the monitoring light having the wavelength λ1 toward the input point 123-1 on the lens 121-1, and allows the rest of the monitoring light to pass through toward the WEST side (the core C1 in the multi-core fiber 300-1).

Next, after the monitoring light having the wavelength λ1 enters the input point 123-1 from the dichroic mirror 110-1, the lens 121-1 allows the monitoring light to exit toward the folding point 125-1 on the mirror 122-1 (S104). Next, the filter 127-1, which allows only light having the wavelength λ1 to pass through, allows the monitoring light having the wavelength λ1, which has exited the lens 121-1, to pass through (S110).

Next, after the monitoring light having the wavelength λ1 enters the folding point 125-1 from the lens 121-1 via the filter 127-1, the mirror 122-1 reflects the monitoring light toward the output point 124-1 on the lens 121-1 (S105). Next, the filter 127-1 allows the monitoring light having the wavelength λ1, which has exited the mirror 122-1, to pass through (S111). Next, after the monitoring light having the wavelength λ1 enters the output point 124-1 from the mirror 122-1 via the filter 127-1, the lens 121-1 allows the monitoring light to exit toward the coupling point 112-1 on the dichroic mirror 110-1 (S106).

Next, the dichroic mirror 110-1, which reflects part of beams of light having the wavelengths λ1 and λ2 and allows the rest of the beams of light having the wavelengths λ1 and λ2 and light having another wavelength to pass through, after the monitoring light having the wavelength λ1 enters the coupling point 112-1 from the lens 121-1, reflects part of the monitoring light having the wavelength λ1 toward the core C2 in the MC-EDF 201 (S107).

Next, similar to those illustrated in FIG. 8, the monitoring light having the wavelength λ1, which has been reflected by the dichroic mirror 110-1, enters, via the isolator 202-3, the core C2 in the MC-EDF 201 for amplification (S108). The amplified monitoring light exits toward the dichroic mirror 110-2 via the isolator 202-4 (S109). The dichroic mirror 110-2, which reflects part of beams of light having the wavelengths λ1 and λ2 and allows the rest of the beams of light having the wavelengths λ1 and λ2 and light having another wavelength to pass through, reflects part of the monitoring light having the wavelength λ1 toward the input point 123-2 on the lens 121-2, and allows the rest of the monitoring light to pass through toward the EAST side (the core C2 in the multi-core fiber 300-2).

Next, after the monitoring light having the wavelength λ1 enters the input point 123-2 from the dichroic mirror 110-2, the lens 121-2 allows the monitoring light to exit toward the folding point 125-2 on the mirror 122-2 (S112). Next, the filter 127-2, which allows only light having the wavelength λ2 to pass through, blocks the monitoring light having the wavelength λ1, which has exited the lens 121-2, without allowing the monitoring light to pass through (S113). After that, similar to those illustrated in FIG. 8, loopback measurements are performed in the end station on the EAST side.

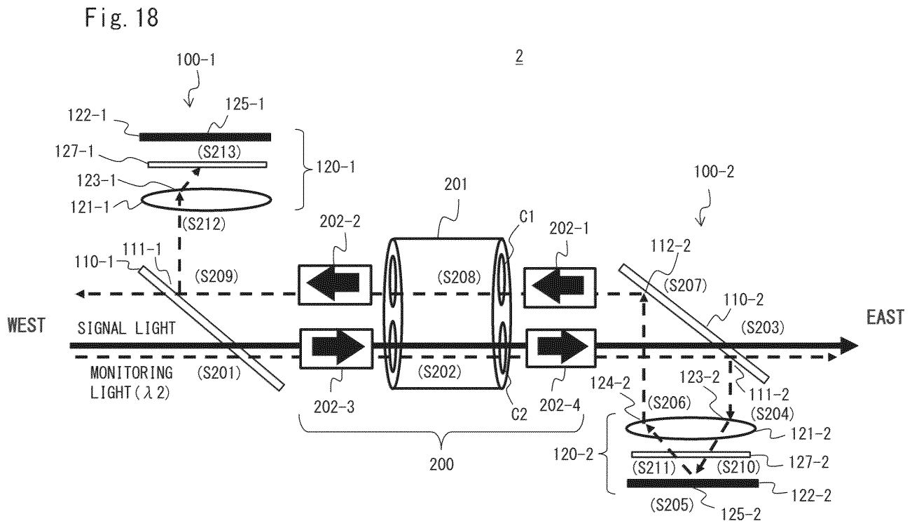

FIG. 18 illustrates an operation example of a case where the folding optical system 100-2 illustrated in FIG. 16 folds back monitoring light and loopback measurements are performed. In the example illustrated in FIG. 18, similar to those illustrated in FIG. 9, monitoring light having the wavelength λ2 from the WEST side is folded back in the folding optical system 100-2.

Monitoring light having the wavelength λ2, which is propagated from the WEST side (the core C2 in the multi-core fiber 300-1), first enters the dichroic mirror 110-1 on the WEST side (S201). The dichroic mirror 110-1, which reflects part of beams of light having the wavelengths λ1 and λ2 and allows the rest of the beams of light having the wavelengths λ1 and λ2 and light having another wavelength to pass through, allows part of the entered monitoring light having the wavelength λ2 to pass through toward the core C2 in the MC-EDF 201.

Next, similar to those illustrated in FIG. 9, the monitoring light having the wavelength λ2, which has passed through the dichroic mirror 110-1, enters, via the isolator 202-3, the core C2 in the MC-EDF 201 for amplification (S202). The amplified monitoring light exits toward the branch point 111-2 on the dichroic mirror 110-2 via the isolator 202-4 (S203). The dichroic mirror 110-2, which reflects part of beams of light having the wavelengths λ1 and λ2 and allows the rest of the beams of light having the wavelengths λ1 and λ2 and light having another wavelength to pass through, after the monitoring light having the wavelength λ2 enters the branch point 111-2 from the isolator 202-4, reflects part of the monitoring light having the wavelength λ2 toward the input point 123-2 on the lens 121-2, and allows the rest of the monitoring light to pass through toward the EAST side (the core C2 in the multi-core fiber 300-2).

Next, after the monitoring light having the wavelength λ2 enters the input point 123-2 from the dichroic mirror 110-2, the lens 121-2 allows the monitoring light to exit toward the folding point 125-2 on the mirror 122-2 (S204). Next, the filter 127-2, which allows only light having the wavelength λ2 to pass through, allows the monitoring light having the wavelength λ2, which has exited the lens 121-2, to pass through (S210).

Next, after the monitoring light having the wavelength λ2 enters the folding point 125-2 from the lens 121-2 via the filter 127-2, the mirror 122-2 reflects the monitoring light toward the output point 124-2 on the lens 121-2 (S205). Next, the filter 127-2 allows the monitoring light having the wavelength λ2, which has exited the mirror 122-2, to pass through (S211). Next, after the monitoring light having the wavelength λ2 enters the output point 124-2 from the mirror 122-2 via the filter 127-2, the lens 121-2 allows the monitoring light to exit toward the coupling point 112-2 on the dichroic mirror 110-2 (S206).

Next, the dichroic mirror 110-2, which reflects part of beams of light having the wavelengths λ1 and λ2 and allows the rest of the beams of light having the wavelengths λ1 and λ2 and light having another wavelength to pass through, after the monitoring light having the wavelength λ2 enters the coupling point 112-2 from the lens 121-2, reflects part of the monitoring light having the wavelength λ2 toward the core C1 in the MC-EDF 201 (S207).

Next, similar to those illustrated in FIG. 9, the monitoring light having the wavelength λ2, which has been reflected by the dichroic mirror 110-2, enters, via the isolator 202-1, the core C1 in the MC-EDF 201 for amplification (S208). The amplified monitoring light exits toward the dichroic mirror 110-1 via the isolator 202-2 (S209). The dichroic mirror 110-2, which reflects part of beams of light having the wavelengths λ1 and λ2 and allows the rest of the beams of light having the wavelengths λ1 and λ2 and light having another wavelength to pass through, reflects part of the monitoring light having the wavelength λ2 toward the input point 123-1 on the lens 121-1, and allows the rest of the monitoring light to pass through toward the WEST side (the core C1 in the multi-core fiber 300-1).

Next, after the monitoring light having the wavelength λ2 enters the input point 123-1 from the dichroic mirror 110-1, the lens 121-1 allows the monitoring light to exit toward the folding point 125-1 on the mirror 122-1 (S212). Next, the filter 127-1, which allows only light having the wavelength λ1 to pass through, blocks the monitoring light having the wavelength λ2, which has exited the lens 121-1, without allowing the monitoring light to pass through (S213). After that, similar to those illustrated in FIG. 9, loopback measurements are performed in the end station on the WEST side.

As described above, beams of light having two types of wavelengths may be reflected by a dichroic mirror of a folding optical system, and a filter that allows only light having a wavelength necessary for the folding optical system to pass through may be provided. For example, it may be difficult to form a dichroic mirror having a characteristic of reflecting only the wavelength λ1 or only the wavelength λ2. Therefore, a folding optical system may be configured by using a dichroic mirror that reflects beams of light having the wavelengths λ1 and λ2, which are easily formed.

### Fourth Example Embodiment

Next, a fourth example embodiment will be described. In the present example embodiment, an example in which folding back for OTDR is further performed in the folding optical system described in the second example embodiment will be described. The present example embodiment may be applied to the folding optical system described in the third example embodiment.

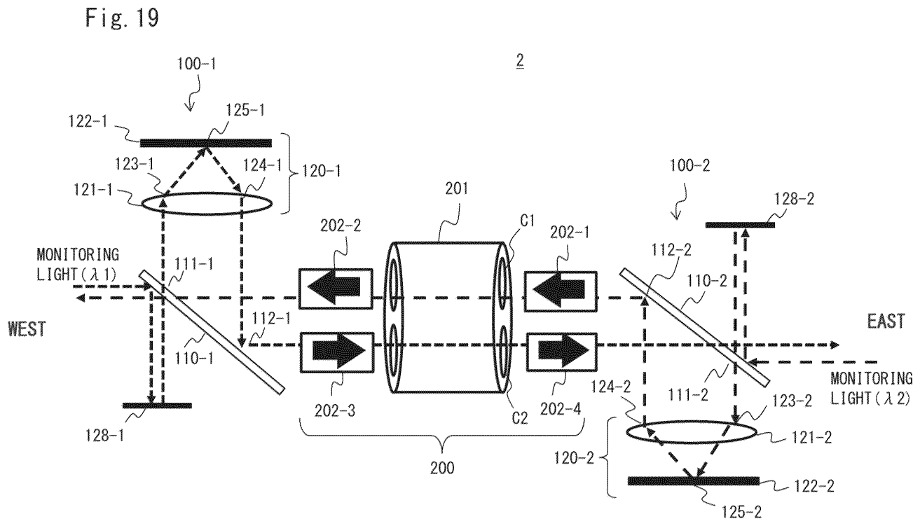

FIG. 19 illustrates a configuration example of the optical repeater 2 according to some example embodiments. In the example illustrated in FIG. 19, the folding optical system 100 further includes a mirror 128 (128-1 and 128-2), in addition to the configuration illustrated in FIG. 7. For OTDR measurements, the mirror 128 reflects again, toward the dichroic mirror 110, monitoring light that has been scattered in the multi-core fiber and reflected from the dichroic mirror 110.

The mirror 128-1 is disposed on a side opposite to the reflector 120-1 with respect to the branch point 111-1 on the dichroic mirror 110-1. The mirror 128-1 reflects again, toward the branch point 111-1 on the dichroic mirror 110-1, monitoring light reflected from the branch point 111-1 on the dichroic mirror 110-1 (toward the side opposite to the reflector 120-1). The mirror 128-2 is disposed on a side opposite to the reflector 120-2 with respect to the branch point 111-2 on the dichroic mirror 110-2. The mirror 128-2 reflects again, toward the branch point 111-2 on the dichroic mirror 110-2, monitoring light reflected from the branch point 111-2 on the dichroic mirror 110-2 (toward the side opposite to the reflector 120-2). Others are similar to those illustrated in FIG. 7.

Operation of a case where loopback measurements are to be performed in the folding optical system 100 illustrated in FIG. 19 is similar or identical to that in the second example embodiment. That is, the folding optical system 100-1 folds back monitoring light having the wavelength λ1 from the EAST side toward the EAST side, similar to those illustrated in FIG. 8. The folding optical system 100-2 folds back monitoring light having the wavelength λ2 from the WEST side toward the WEST side, similar to those illustrated in FIG. 9.

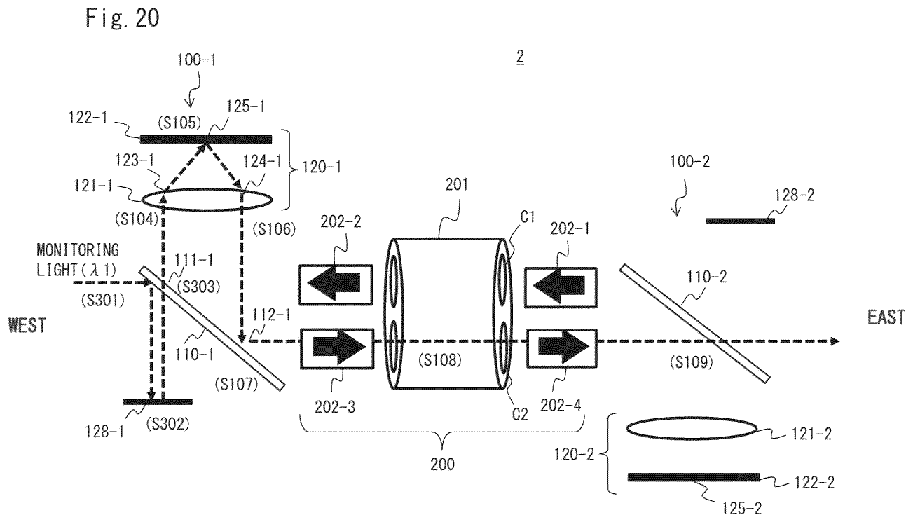

FIG. 20 illustrates an operation example of a case where the folding optical system 100-1 illustrated in FIG. 19 folds back monitoring light and OTDR measurements are performed. In the example illustrated in FIG. 20, monitoring light having the wavelength λ1, which has been transmitted from the EAST side toward the WEST side and scattered in the multi-core fiber on the WEST side, is transmitted toward the EAST side with the folding optical system 100-1.

Monitoring light having the wavelength λ1 is first allowed to be scattered on the WEST side (the core C1 in the multi-core fiber 300-1), propagates toward the EAST side, and enters the branch point 111-1 (a surface on the WEST side) on the dichroic mirror 110-1 on the WEST side (S301). The dichroic mirror 110-1, which reflects part of light having the wavelength λ1 and allows the rest of the light having the wavelength λ1 and light having another wavelength to pass through, reflects part of the monitoring light having the wavelength λ1 toward the mirror 128-1 and allows the rest of the monitoring light to pass through toward the isolator 202-2. The monitoring light having the wavelength λ1, which has passed through the dichroic mirror 110-1, is blocked by the isolator 202-2 and does not enter the core C1 in the MC-EDF 201.

Next, after the monitoring light having the wavelength λ1 from the dichroic mirror 110-1 enters, the mirror 128-1 reflects the monitoring light again toward the branch point 111-1 on the dichroic mirror 110-1 (S302).

Next, the dichroic mirror 110-1, which reflects part of light having the wavelength λ1 and allows the rest of the light having the wavelength λ1 and light having another wavelength to pass through, after the monitoring light having the wavelength λ1 enters the branch point 111-1 (the surface on the WEST side) from the mirror 128-1, reflects part of the monitoring light having the wavelength λ1 toward the WEST side and allows the rest of the monitoring light to pass through toward the input point 123-1 on the lens 121-1 (S303).

After that, similar to those illustrated in FIG. 8, the monitoring light having the wavelength λ1, which has passed through the dichroic mirror 110-1, is reflected toward the coupling point 112-1 on the dichroic mirror 110-1 with the lens 121-1 and the mirror 122-1 (S104 to S106), and part of the monitoring light having the wavelength λ1 is reflected from the dichroic mirror 110-1 toward the core C2 in the MC-EDF 201 (S107). The monitoring light having the wavelength λ1, which has been reflected by the dichroic mirror 110-1, enters, via the isolator 202-3, the core C2 in the MC-EDF 201 for amplification (S108). The monitoring light amplified in the core C2 in the MC-EDF 201 propagates toward the EAST side (the core C2 in the multi-core fiber 300-2) via the isolator 202-4 and the dichroic mirror 110-2 (S109).

After that, the end station on the EAST side uses the monitoring light that has been folded back to perform OTDR measurements. The end station on the EAST side measures the power of the received monitoring light and monitors the transmission state of the core C1 in the multi-core fiber 300-1.

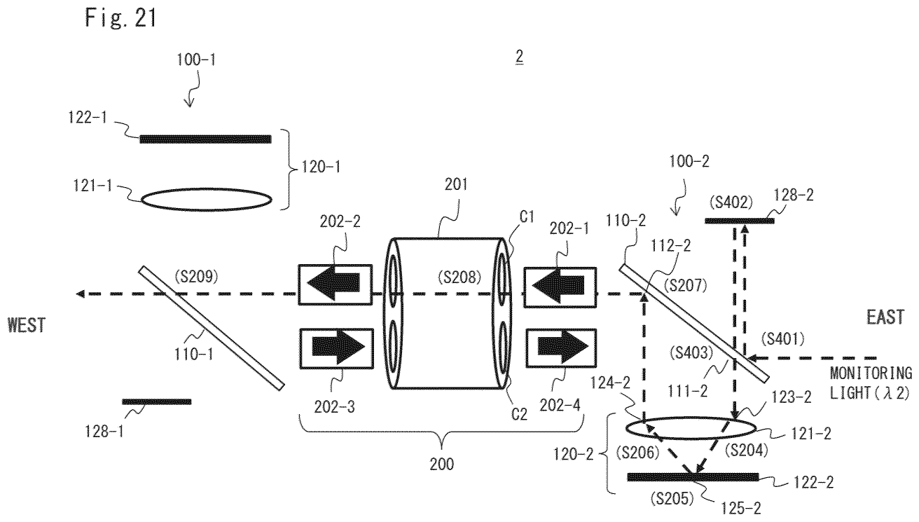

FIG. 21 illustrates an operation example of a case where the folding optical system 100-2 illustrated in FIG. 19 folds back monitoring light and OTDR measurements are performed. In the example illustrated in FIG. 21, monitoring light having the wavelength λ2, which has been transmitted from the WEST side toward the EAST side and scattered in the multi-core fiber on the EAST side, is transmitted toward the WEST side with the folding optical system 100-2.

Monitoring light having the wavelength λ2 is first allowed to be scattered on the EAST side (the core C2 in the multi-core fiber 300-2), propagates toward the WEST side, and enters the branch point 111-2 (a surface on the EAST side) on the dichroic mirror 110-2 on the EAST side (S401). The dichroic mirror 110-2, which reflects part of light having the wavelength λ2 and allows the rest of the light having the wavelength λ2 and light having another wavelength to pass through, reflects part of the monitoring light having the wavelength λ2 toward the mirror 128-2 and allows the rest of the monitoring light to pass through toward the isolator 202-4. The monitoring light having the wavelength λ2, which has passed through the dichroic mirror 110-2, is blocked by the isolator 202-4 and does not enter the core C2 in the MC-EDF 201.

Next, after the monitoring light having the wavelength λ2 from the dichroic mirror 110-2 enters, the mirror 128-2 reflects the monitoring light again toward the branch point 111-2 on the dichroic mirror 110-2 (S402).

Next, the dichroic mirror 110-2, which reflects part of light having the wavelength λ2 and allows the rest of the light having the wavelength λ2 and light having another wavelength to pass through, after the monitoring light having the wavelength λ2 enters the branch point 111-2 (the surface on the EAST side) from the mirror 128-2, reflects part of the monitoring light having the wavelength λ2 toward the EAST side and allows the rest of the monitoring light to pass through toward the input point 123-2 on the lens 121-2 (S403).

After that, similar to those illustrated in FIG. 9, the monitoring light having the wavelength λ2, which has passed through the dichroic mirror 110-2, is reflected toward the coupling point 112-2 on the dichroic mirror 110-2 with the lens 121-2 and the mirror 122-2 (S204 to S206), and part of the monitoring light having the wavelength λ2 is reflected from the dichroic mirror 110-2 toward the core C1 in the MC-EDF 201 (S207). The monitoring light having the wavelength λ2, which has been reflected by the dichroic mirror 110-2, enters, via the isolator 202-1, the core C1 in the MC-EDF 201 for amplification (S208). The monitoring light amplified in the core C1 in the MC-EDF 201 propagates toward the WEST side (the core C1 in the multi-core fiber 300-1) via the isolator 202-2 and the dichroic mirror 110-1 (S209).

After that, the end station on the WEST side uses the monitoring light that has been folded back to perform OTDR measurements. The end station on the WEST side measures the power of the received monitoring light and monitors the transmission state of the core C2 in the multi-core fiber 300-2.

Between monitoring light for loopback measurements and monitoring light for OTDR measurements, the wavelengths may be identical to or differ from each other. For example, monitoring light having the wavelength λ1 may be transmitted from the EAST side toward the WEST side, and loopback measurements and OTDR measurements may be performed with the monitoring light folded back toward the EAST side. Monitoring light having the wavelength λ2 may be transmitted from the WEST side toward the EAST side, and loopback measurements and OTDR measurements may be performed with the monitoring light folded back toward the WEST side. In this case, folding back of monitoring light for loopback measurements and folding back of monitoring light for OTDR measurements may be performed in the single folding optical system 100. For example, as illustrated in FIG. 19, the folding optical system 100-1 for folding back monitoring light having the wavelength λ1 for loopback measurements and OTDR measurements and the folding optical system 100-2 for folding back monitoring light having the wavelength λ2 for loopback measurements and OTDR measurements may be provided.

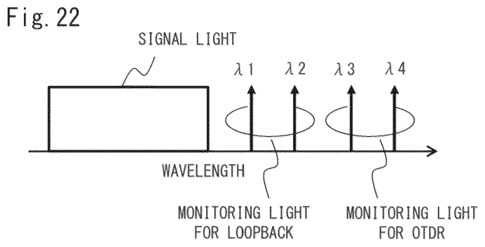

FIG. 22 illustrates an example of wavelength bands in a case where, between monitoring light for loopback measurements and monitoring light for OTDR measurements, the wavelengths differ from each other. In the example illustrated in FIG. 22, beams of monitoring light for loopback have the wavelengths λ1 and λ2, and beams of monitoring light for OTDR measurements have wavelengths λ3 and λ4. Since an operational state of the optical amplifier is monitored in loopback measurements, a wavelength of monitoring light for loopback measurements more likely falls within a wavelength band for signal light than a wavelength of monitoring light for OTDR measurements.

For example, monitoring light having the wavelength λ1 may be transmitted from the EAST side toward the WEST side, and loopback measurements may be performed with the monitoring light folded back toward the EAST side, and monitoring light having the wavelength λ2 may be transmitted from the WEST side toward the EAST side, and loopback measurements may be performed with the monitoring light folded back toward the WEST side. Monitoring light having the wavelength λ3 may be transmitted from the EAST side toward the WEST side, and OTDR measurements may be performed with the monitoring light that is allowed to be scattered on the WEST side and folded back toward the EAST side, and monitoring light having the wavelength λ4 may be transmitted from the WEST side toward the EAST side, and OTDR measurements may be performed with the monitoring light that is allowed to be scattered on the EAST side and folded back toward the WEST side. In this case, folding back of monitoring light for loopback measurements and folding back of monitoring light for OTDR measurements may be performed in different folding optical systems 100. For example, as illustrated in FIG. 7, the folding optical system 100-1 for folding back monitoring light having the wavelength λ1 for loopback measurements and the folding optical system 100-2 for folding back monitoring light having the wavelength λ2 for loopback measurements, as well as the folding optical system 100-1 (the folding optical system 100-1 for reflecting light having the wavelength λ3 with the dichroic mirror 110-1) for folding back monitoring light having the wavelength λ3 for OTDR measurements and the folding optical system 100-2 (the folding optical system 100-2 for reflecting light having the wavelength λ4 with the dichroic mirror 110-2) for folding back monitoring light having the wavelength λ4 for OTDR measurements, which are similar to those illustrated in FIG. 19, may be provided.

As described above, a mirror that further reflects, toward a dichroic mirror, reflected light generated if the dichroic mirror has reflected monitoring light (scattered light) allowed to be scattered in a multi-core fiber may be added to a folding optical system. With this feature, it is possible, in the folding optical system, to fold back monitoring light for loopback measurements and to fold back monitoring light (scattered light) for OTDR measurements.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for explaining illustrative example embodiments are not necessarily mandatory, and some features or steps may be omitted. The order of the steps described in any of the figures may be changed as appropriate.

Some or all of the above-described example embodiments may be described as the following Supplementary Notes, but are not limited to the following Supplementary Notes.

### (Supplementary Note 1)

A folding optical system including:
a wavelength selection mirror that allows first light having a first wavelength to pass through and reflects second light having a second wavelength, the first light and the second light having propagated through a first core among the first core and a second core included in a multi-core fiber; and
a reflector that folds back the second light reflected by the wavelength selection mirror toward the wavelength selection mirror for coupling into the second core.

### (Supplementary Note 2)

The folding optical system according to Supplementary Note 1, in which
the first light is signal light in an optical transmission system including the folding optical system, and
the second light is monitoring light for monitoring a state of the optical transmission system.

### (Supplementary Note 3)

The folding optical system according to Supplementary Note 2, in which, between the first core and the second core, transmission directions of the signal light differ from each other.

### (Supplementary Note 4)

The folding optical system according to any one of Supplementary Notes 1 to 3, in which the wavelength selection mirror reflects part of the second light having the second wavelength.

### (Supplementary Note 5)

The folding optical system according to any one of Supplementary Notes 1 to 3, in which the wavelength selection mirror is disposed to cross directions of optical axes of the first core and the second core, and reflects the second light in a direction orthogonal to the direction of the optical axis.

### (Supplementary Note 6)

The folding optical system according to any one of Supplementary Notes 1 to 3, in which the wavelength selection mirror is a dichroic mirror.

### (Supplementary Note 7)

The folding optical system according to any one of Supplementary Notes 1 to 3, in which the reflector moves in parallel an optical path of the second light reflected by the wavelength selection mirror, and folds back the second light toward a position on the wavelength selection mirror, the position crossing a direction of an optical axis of the second core.

### (Supplementary Note 8)

The folding optical system according to any one of Supplementary Notes 1 to 3, in which the reflector includes: a lens capable of allowing parallel light to condense; and a reflection mirror capable of reflecting light from the lens at a light-condensing position of the lens.

### (Supplementary Note 9)

The folding optical system according to any one of Supplementary Notes 1 to 3, in which the reflector is a corner cube type reflector.

### (Supplementary Note 10)

The folding optical system according to any one of Supplementary Notes 1 to 3, further including a magnifying lens that magnifies an interval between an optical axis of the first core and an optical axis of the second core,
in which the wavelength selection mirror reflects the second light that has passed through the magnifying lens and allows the second light that has been folded back from the reflector to achieve coupling into the second core via the magnifying lens.

### (Supplementary Note 11)

The folding optical system according to any one of Supplementary Notes 1 to 3, in which
the multi-core fiber includes a third core and a fourth core,
the wavelength selection mirror allows third light having the first wavelength to pass through and reflects fourth light having the second wavelength, the third light and the fourth light having propagated through the third core, and
the reflector folds back the fourth light reflected by the wavelength selection mirror toward the wavelength selection mirror for coupling into the fourth core.

### (Supplementary Note 12)

The folding optical system according to any one of Supplementary Notes 1 to 3, in which
the wavelength selection mirror further reflects light having another wavelength,
a filter that allows the second light having the second wavelength among the light reflected by the wavelength selection mirror to pass through is further included, and
the reflector folds back the second light that has passed through the filter toward the wavelength selection mirror.

### (Supplementary Note 13)

The folding optical system according to any one of Supplementary Notes 1 to 3, in which
the wavelength selection mirror reflects the second light having the second wavelength, the second light having propagated in a direction opposite to a direction of the first light, toward a side opposite to the reflector, and
a reflection mirror that reflects the second light reflected by the wavelength selection mirror again toward the wavelength selection mirror is further included.

### (Supplementary Note 14)

An optical repeater including:
a multi-core optical amplification fiber including a first core and a second core; and
a folding optical system,
in which the folding optical system includes:
a wavelength selection mirror that allows first light having a first wavelength to pass through and reflects second light having a second wavelength, the first light and the second light having propagated through the first core; and
a reflector that folds back the second light reflected by the wavelength selection mirror toward the wavelength selection mirror for coupling into the second core.

### (Supplementary Note 15)

An optical transmission system including an optical repeater coupled between multi-core fibers, in which
the optical repeater includes:
a multi-core optical amplification fiber including a first core and a second core; and
a folding optical system, and
the folding optical system includes:
a wavelength selection mirror that allows first light having a first wavelength to pass through and reflects second light having a second wavelength, the first light and the second light having propagated through the first core; and
a reflector that folds back the second light reflected by the wavelength selection mirror toward the wavelength selection mirror for coupling into the second core.

### (Supplementary Note 16)

An optical folding method including, with a wavelength selection mirror:
allowing first light having a first wavelength to pass through and reflecting second light having a second wavelength, the first light and the second light having propagated through a first core among the first core and a second core included in a multi-core fiber; and
folding back the second light reflected by the wavelength selection mirror toward the wavelength selection mirror for coupling into the second core.

Some or all of the elements (for example, configurations and functions) described in Supplementary Notes 2 to 13 dependent on Supplementary Note 1 (folding optical system) can also be dependent on Supplementary Note 14 (optical repeater), Supplementary Note 15 (optical transmission system), and Supplementary Note 16 (optical folding method) by the same dependency relationship as Supplementary Notes 2 to 13. Some or all of the elements described in any Supplementary Note may be applied to various types of hardware components, software components, recording means for recording software components, systems, and methods.

What is claimed is:

1. A folding optical system comprising:
a wavelength selection mirror that allows first light having a first wavelength to pass through and reflects second light having a second wavelength, the first light and the second light having propagated through a first core among the first core and a second core included in a multi-core fiber; and
a reflector that folds back the second light reflected by the wavelength selection mirror toward the wavelength selection mirror for coupling into the second core.

2. The folding optical system according to claim 1, wherein
the first light is signal light in an optical transmission system including the folding optical system, and
the second light is monitoring light for monitoring a state of the optical transmission system.

3. The folding optical system according to claim 2, wherein, between the first core and the second core, transmission directions of the signal light differ from each other.

4. The folding optical system according to claim 1, wherein the wavelength selection mirror reflects part of the second light having the second wavelength.

5. The folding optical system according to claim 1, wherein the wavelength selection mirror is disposed to cross directions of optical axes of the first core and the second core, and reflects the second light in a direction orthogonal to the direction of the optical axis.

6. The folding optical system according to claim 1, wherein the wavelength selection mirror is a dichroic mirror.

7. The folding optical system according to claim 1, wherein the reflector moves in parallel an optical path of the second light reflected by the wavelength selection mirror, and folds back the second light toward a position on the wavelength selection mirror, the position crossing a direction of an optical axis of the second core.

8. The folding optical system according to claim 1, wherein the reflector includes: a lens capable of allowing parallel light to condense; and a reflection mirror capable of reflecting light from the lens at a light-condensing position of the lens.

9. The folding optical system according to claim 1, wherein the reflector is a corner cube type reflector.

10. The folding optical system according to claim 1, further comprising a magnifying lens that magnifies an interval between an optical axis of the first core and an optical axis of the second core,
wherein the wavelength selection mirror reflects the second light that has passed through the magnifying lens and allows the second light that has been folded back from the reflector to achieve coupling into the second core via the magnifying lens.

11. The folding optical system according to claim 1, wherein
the multi-core fiber includes a third core and a fourth core,
the wavelength selection mirror allows third light having the first wavelength to pass through and reflects fourth light having the second wavelength, the third light and the fourth light having propagated through the third core, and
the reflector folds back the fourth light reflected by the wavelength selection mirror toward the wavelength selection mirror for coupling into the fourth core.

12. The folding optical system according to claim 1, wherein
the wavelength selection mirror further reflects light having another wavelength,
a filter that allows the second light having the second wavelength among the light reflected by the wavelength selection mirror to pass through is further included, and
the reflector folds back the second light that has passed through the filter toward the wavelength selection mirror.

13. The folding optical system according to claim 1, wherein
the wavelength selection mirror reflects the second light having the second wavelength, the second light having propagated in a direction opposite to a direction of the first light, toward a side opposite to the reflector, and
a reflection mirror that reflects the second light reflected by the wavelength selection mirror again toward the wavelength selection mirror is further included.

14. An optical repeater comprising:
a multi-core optical amplification fiber including a first core and a second core; and
a folding optical system,
wherein the folding optical system includes:
a wavelength selection mirror that allows first light having a first wavelength to pass through and reflects second light having a second wavelength, the first light and the second light having propagated through the first core; and
a reflector that folds back the second light reflected by the wavelength selection mirror toward the wavelength selection mirror for coupling into the second core.

15. An optical transmission system comprising
an optical repeater coupled between multi-core fibers, wherein
the optical repeater includes:
a multi-core optical amplification fiber including a first core and a second core; and
a folding optical system, and
the folding optical system includes:
a wavelength selection mirror that allows first light having a first wavelength to pass through and reflects second light having a second wavelength, the first light and the second light having propagated through the first core; and
a reflector that folds back the second light reflected by the wavelength selection mirror toward the wavelength selection mirror for coupling into the second core.
